(19) United States
(12) Patent Application Publication
(10) Pub. No.: US 2025/0294472 A1
(43) Pub. Date: Sep. 18, 2025

(54) POWER CONTROL FOR MULTI-TRANSMISSION SCHEDULING

(71) Applicant: QUALCOMM INCORPORATED, San Diego, CA (US)

(72) Inventors: Zhichao ZHOU, Beijing (CN); Huilin XU, Temecula, CA (US); Ahmed ELSHAFIE, San Diego, CA (US); Diana MAAMARI, San Diego, CA (US)

(21) Appl. No.: 18/861,392

(22) PCT Filed: Jun. 30, 2022
(86) PCT No.: PCT/CN2022/102825

§ 371 Date: Oct. 29, 2024

(51) Int. Cl. H04W 52/28; H04W 52/14

(52) U.S. Cl. CPC H04W 52/281; H04W 52/146

(57) ABSTRACT

Various aspects of the present disclosure generally relate to wireless communication. In some aspects, a user equipment (UE) may receive a configuration of transmission resources that are associated with multiple transmission occasions associated with a packet data unit (PDU) set. The UE may transmit or receive the PDU set by: transmitting or receiving a first subset of one or more PDUs, of the PDU set, using a first subset of one or more transmission occasions, wherein the first subset of one or more PDUs is associated with a first transmit power; and transmitting or receiving a second subset of one or more PDUs, of the PDU set, using a second subset of one or more transmission occasions, wherein the second subset of one or more PDUs is associated with a second transmit power different than the first transmit power. Numerous other aspects are described.

### FIELD OF THE DISCLOSURE

Aspects of the present disclosure generally relate to wireless communication and to techniques and apparatuses for power control for multi-transmission scheduling.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration of transmission resources, wherein the transmission resources are associated with multiple transmission occasions associated with a packet data unit (PDU) set. The method may include transmitting or receiving the PDU set by: transmitting or receiving a first subset of one or more PDUs, of the PDU set, using a first subset of one or more transmission occasions, of the multiple transmission occasions, where the first subset of one or more PDUs is associated with a first transmit power; and transmitting or receiving a second subset of one or more PDUs, of the PDU set, using a second subset of one or more transmission occasions, of the multiple transmission occasions, where the second subset of one or more PDUs is associated with a second transmit power different than the first transmit power.

Some aspects described herein relate to a method of wireless communication performed by a network node. The method may include transmitting, to a UE, a configuration of transmission resources, wherein the transmission resources are associated with multiple transmission occasions associated with a PDU set. The method may include transmitting to the UE or receiving from the UE the PDU set by: transmitting or receiving a first subset of one or more PDUs, of the PDU set, using a first subset of one or more transmission occasions, of the multiple transmission occasions, where the first subset of one or more PDUs is associated with a first transmit power; and transmitting or receiving a second subset of one or more PDUs, of the PDU set, using a second subset of one or more transmission occasions, of the multiple transmission occasions, where the second subset of one or more PDUs is associated with a second transmit power different than the first transmit power.

Some aspects described herein relate to an apparatus for wireless communication at a UE. The apparatus may include a memory and one or more processors coupled to the memory. The one or more processors may be configured to receive a configuration of transmission resources, wherein the transmission resources are associated with multiple transmission occasions associated with a PDU set. The one or more processors may be configured to transmit or receive the PDU set by: transmitting or receiving a first subset of one or more PDUs, of the PDU set, using a first subset of one or more transmission occasions, of the multiple transmission occasions, where the first subset of one or more PDUs is associated with a first transmit power; and transmitting or receiving a second subset of one or more PDUs, of the PDU set, using a second subset of one or more transmission occasions, of the multiple transmission occasions, where the second subset of one or more PDUs is associated with a second transmit power different than the first transmit power.

Some aspects described herein relate to an apparatus for wireless communication at a network node. The apparatus may include a memory and one or more processors coupled to the memory. The one or more processors may be configured to transmit, to a UE, a configuration of transmission resources, wherein the transmission resources are associated with multiple transmission occasions associated with a PDU set. The one or more processors may be configured to transmit to the UE or receive from the UE the PDU set by: transmitting or receiving a first subset of one or more PDUs, of the PDU set, using a first subset of one or more transmission occasions, of the multiple transmission occasions, where the first subset of one or more PDUs is associated with a first transmit power; and transmitting or receiving a second subset of one or more PDUs, of the PDU set, using a second subset of one or more transmission occasions, of the multiple transmission occasions, where the second subset of one or more PDUs is associated with a second transmit power different than the first transmit power.

Some aspects described herein relate to a non-transitory computer-readable medium that stores a set of instructions for wireless communication by a UE. The set of instructions, when executed by one or more processors of the UE, may cause the UE to receive a configuration of transmission resources, wherein the transmission resources are associated with multiple transmission occasions associated with a PDU set. The set of instructions, when executed by one or more processors of the UE, may cause the UE to transmit or receive the PDU set by: transmitting or receiving a first subset of one or more PDUs, of the PDU set, using a first subset of one or more transmission occasions, of the multiple transmission occasions, where the first subset of one or more PDUs is associated with a first transmit power; and transmitting or receiving a second subset of one or more PDUs, of the PDU set, using a second subset of one or more transmission occasions, of the multiple transmission occasions, where the second subset of one or more PDUs is associated with a second transmit power different than the first transmit power.

Some aspects described herein relate to a non-transitory computer-readable medium that stores a set of instructions for wireless communication by a network node. The set of instructions, when executed by one or more processors of the network node, may cause the network node to transmit, to a UE, a configuration of transmission resources, wherein the transmission resources are associated with multiple transmission occasions associated with a PDU set. The set of instructions, when executed by one or more processors of the network node, may cause the network node to transmit to the UE or receive from the UE the PDU set by: transmitting or receiving a first subset of one or more PDUs, of the PDU set, using a first subset of one or more transmission occasions, of the multiple transmission occasions, where the first subset of one or more PDUs is associated with a first transmit power; and transmitting or receiving a second subset of one or more PDUs, of the PDU set, using a second subset of one or more transmission occasions, of the multiple transmission occasions, where the second subset of one or more PDUs is associated with a second transmit power different than the first transmit power.

Some aspects described herein relate to an apparatus for wireless communication. The apparatus may include means for receiving a configuration of transmission resources, wherein the transmission resources are associated with multiple transmission occasions associated with a PDU set. The apparatus may include means for transmitting or receiving the PDU set by: transmitting or receiving a first subset of one or more PDUs, of the PDU set, using a first subset of one or more transmission occasions, of the multiple transmission occasions, where the first subset of one or more PDUs is associated with a first transmit power; and transmitting or receiving a second subset of one or more PDUs, of the PDU set, using a second subset of one or more transmission occasions, of the multiple transmission occasions, where the second subset of one or more PDUs is associated with a second transmit power different than the first transmit power.

Some aspects described herein relate to an apparatus for wireless communication. The apparatus may include means for transmitting, to a UE, a configuration of transmission resources, wherein the transmission resources are associated with multiple transmission occasions associated with a PDU set. The apparatus may include means for transmitting to the UE or receiving from the UE the PDU set by: transmitting or receiving a first subset of one or more PDUs, of the PDU set, using a first subset of one or more transmission occasions, of the multiple transmission occasions, where the first subset of one or more PDUs is associated with a first transmit power; and transmitting or receiving a second subset of one or more PDUs, of the PDU set, using a second subset of one or more transmission occasions, of the multiple transmission occasions, where the second subset of one or more PDUs is associated with a second transmit power different than the first transmit power.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a packet data unit session for handling various quality of service flows, in accordance with the present disclosure.

FIG. 5 is a diagram illustrating an example of downlink semi-persistent scheduling communication and an example of uplink configured grant communication, in accordance with the present disclosure.

FIG. 6 is a diagram illustrating an example of a downlink control information (DCI) communication scheduling multiple downlink communications and an example of a DCI communication scheduling multiple uplink communications, in accordance with the present disclosure.

FIG. 7 is a diagram illustrating an example and an example associated with power control for multi-transmission scheduling, in accordance with the present disclosure.

FIG. 8 is a diagram illustrating another example associated with power control for multi-transmission scheduling, in accordance with the present disclosure.

FIG. 9 is a diagram illustrating another example associated with power control for multi-transmission scheduling, in accordance with the present disclosure.

FIG. 10 is a diagram illustrating an example process performed, for example, by a UE, in accordance with the present disclosure.

FIG. 11 is a diagram illustrating an example process performed, for example, by a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

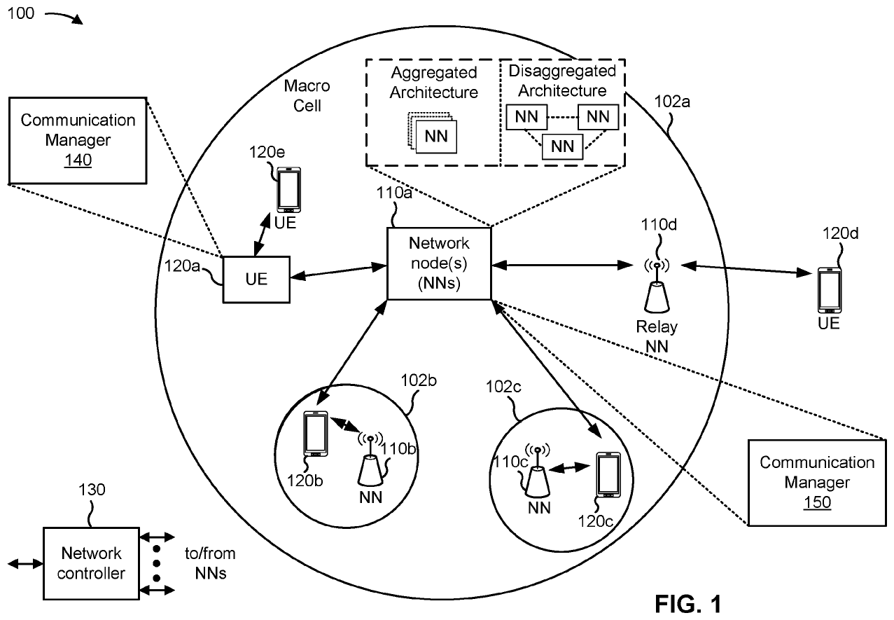

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration of transmission resources, wherein the transmission resources are associated with multiple transmission occasions associated with a packet data unit (PDU) set; and transmit or receive the PDU set by: transmitting or receiving a first subset of one or more PDUs, of the PDU set, using a first subset of one or more transmission occasions, of the multiple transmission occasions, wherein the first subset of one or more PDUs is associated with a first transmit power; and transmitting or receiving a second subset of one or more PDUs, of the PDU set, using a second subset of one or more transmission occasions, of the multiple transmission occasions, wherein the second subset of one or more PDUs is associated with a second transmit power different than the first transmit power. Additionally, or alternatively, the communication manager 140 may perform one or more other operations described herein.

In some aspects, the network node 110 may include a communication manager 150. As described in more detail elsewhere herein, the communication manager 150 may transmit, to a UE 120, a configuration of transmission resources, wherein the transmission resources are associated with multiple transmission occasions associated with a PDU set; and transmit to the UE or receiving from the UE the PDU set by: transmitting or receiving a first subset of one or more PDUs, of the PDU set, using a first subset of one or more transmission occasions, of the multiple transmission occasions, wherein the first subset of one or more PDUs is associated with a first transmit power; and transmitting or receiving a second subset of one or more PDUs, of the PDU set, using a second subset of one or more transmission occasions, of the multiple transmission occasions, wherein the second subset of one or more PDUs is associated with a second transmit power different than the first transmit power. Additionally, or alternatively, the communication manager 150 may perform one or more other operations described herein.

As indicated above, FIG. 1 is provided as an example. Other examples may differ from what is described with regard to FIG. 1.

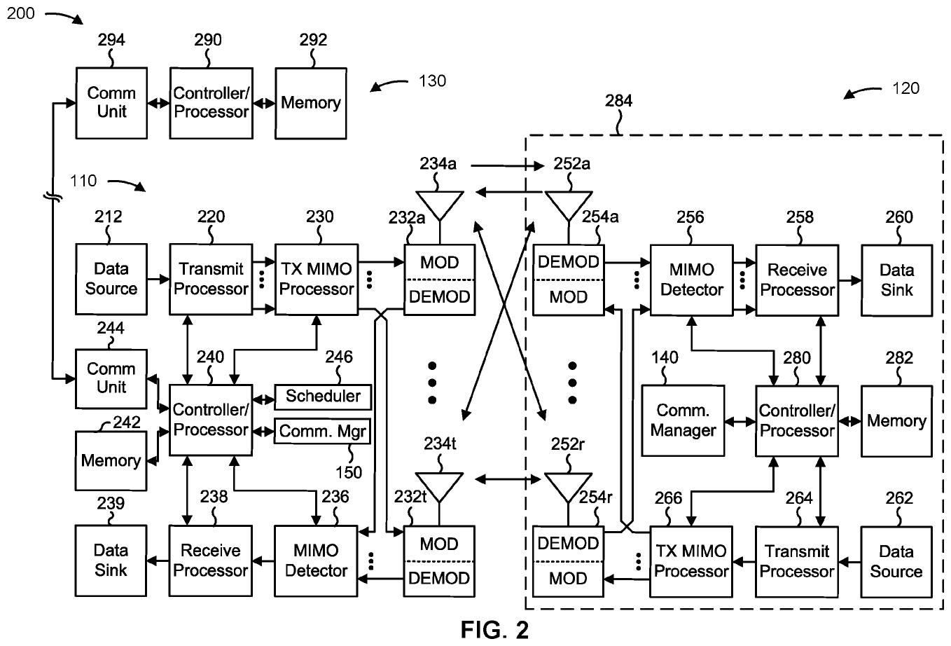

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

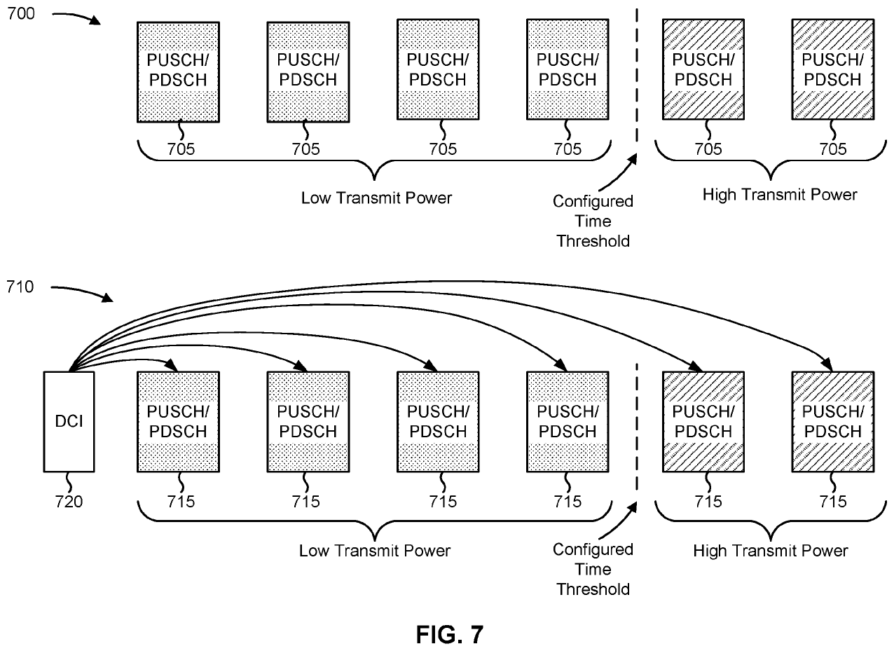

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-13).

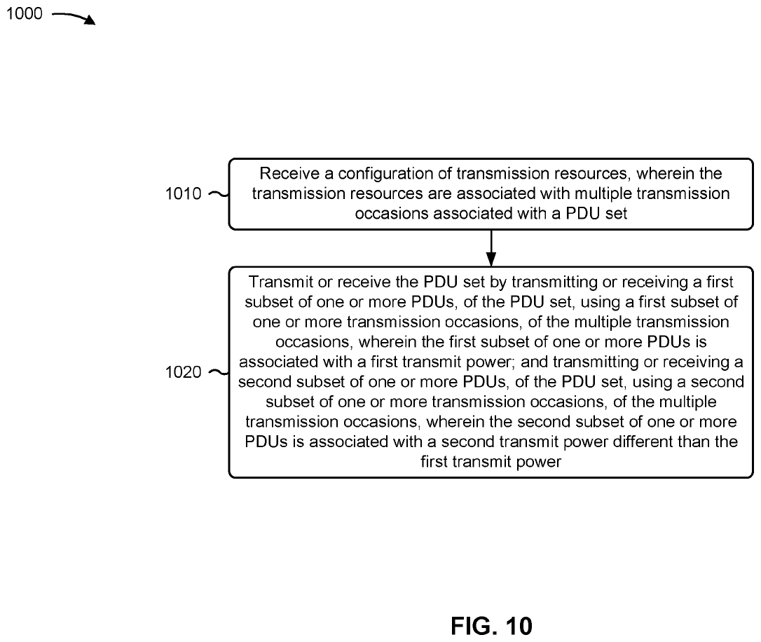

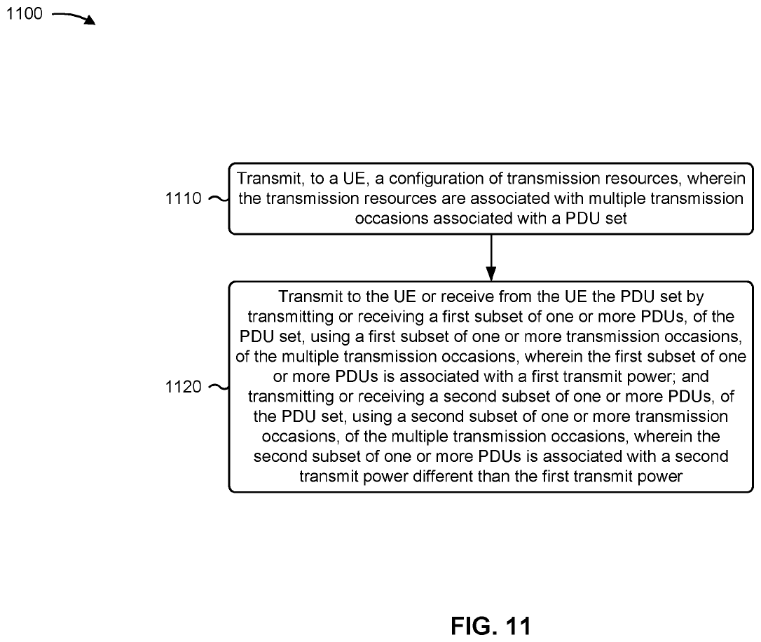

The controller/processor 240 of the network node 110, the controller/processor 280 of the UE 120, and/or any other component(s) of FIG. 2 may perform one or more techniques associated with power control for multi-transmission scheduling, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the UE 120 includes means for receiving a configuration of transmission resources, wherein the transmission resources are associated with multiple transmission occasions associated with a PDU set; and/or means for transmitting or receiving the PDU set by: transmitting or receiving a first subset of one or more PDUs, of the PDU set, using a first subset of one or more transmission occasions, of the multiple transmission occasions, wherein the first subset of one or more PDUs is associated with a first transmit power; and/or transmitting or receiving a second subset of one or more PDUs, of the PDU set, using a second subset of one or more transmission occasions, of the multiple transmission occasions, wherein the second subset of one or more PDUs is associated with a second transmit power different than the first transmit power. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE 120, a configuration of transmission resources, wherein the transmission resources are associated with multiple transmission occasions associated with a PDU set; and/or means for transmitting to the UE 120 or receiving from the UE 120 the PDU set by: transmitting or receiving a first subset of one or more PDUs, of the PDU set, using a first subset of one or more transmission occasions, of the multiple transmission occasions, wherein the first subset of one or more PDUs is associated with a first transmit power; and/or transmitting or receiving a second subset of one or more PDUs, of the PDU set, using a second subset of one or more transmission occasions, of the multiple transmission occasions, wherein the second subset of one or more PDUs is associated with a second transmit power different than the first transmit power. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

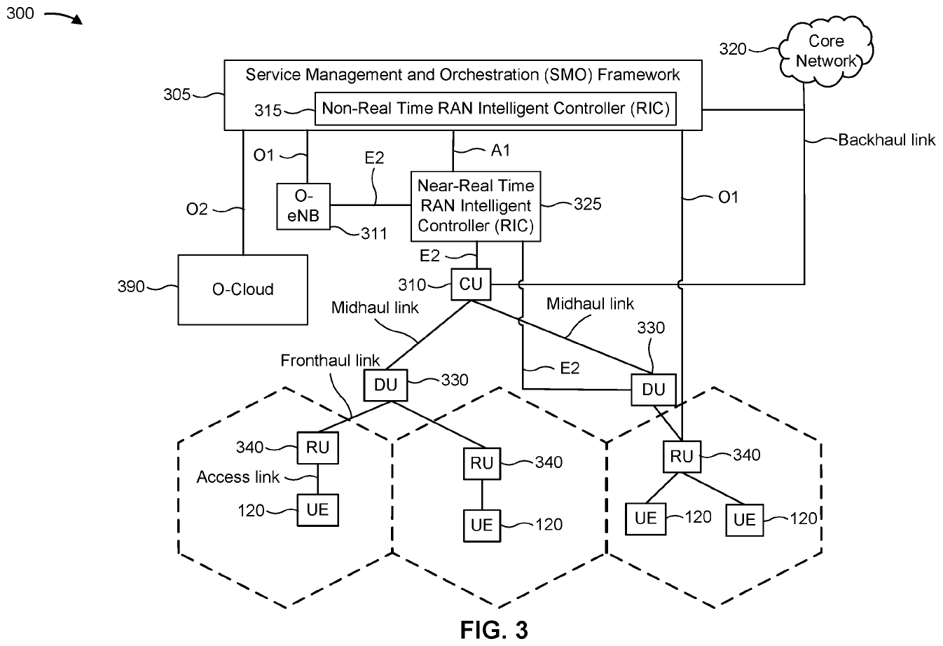

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

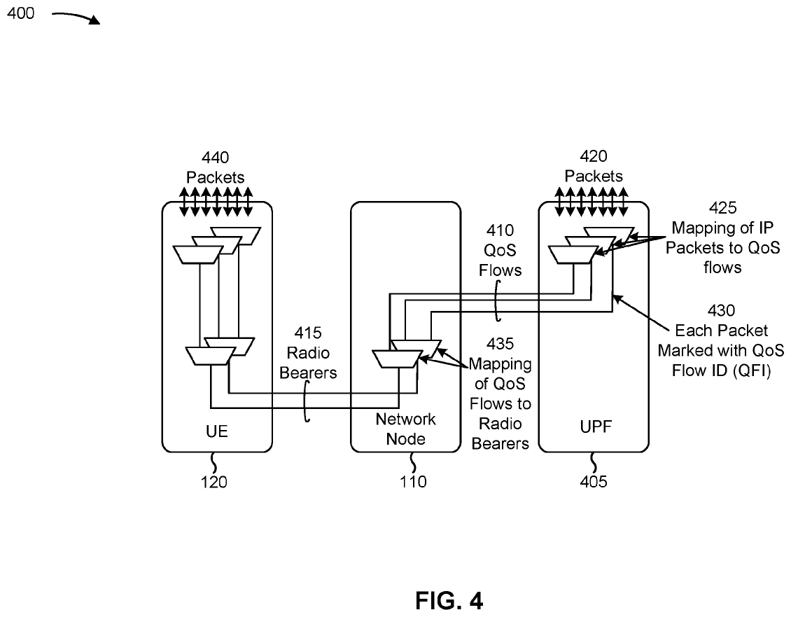

FIG. 4 is a diagram illustrating an example 400 of a PDU session for handling various quality of service (QOS) flows, in accordance with the present disclosure. As shown in FIG. 4, a UE 120, a network node 110, and a user plane function (UPF) 405 of a core network may communicate with each other using one or more QoS flows 410 and one or more radio bearers 415. Although shown as an integral unit for ease of description, in some aspects (e.g., in aspects implementing an O-RAN architecture), the network node 110 may be disaggregated, as described in connection with FIG. 3.

The example PDU session shown in FIG. 4 may be established when the UE 120 connects to a wireless network (e.g., the wireless network 100) via the network node 110. The PDU session may be established for purposes of handling multiple QoS flows, with all traffic within a given QoS flow receiving the same forwarding treatment. For example, time-sensitive communications may be associated with a relatively high QoS priority, and thus may be mapped to a QoS flow associated with a relatively low packet delay budget (PDB) or similar QoS parameters such that the communications are forwarded largely uninterrupted. Other communications, however, which are not as time sensitive, may be associated with a relatively low QoS priority, and thus may be mapped to a QoS flow having a relatively high PDB and similar QoS parameters.

As shown by reference number 420, data packets or the like may be received at the UPF 405 or a similar network controller. As shown by reference number 425, the UPF 405 may map the packets to one of multiple QoS flows 410 according to a QoS priority or the like. The UPF 405 may map the packets to the QoS flows according to certain QoS requirements, such as maximum permissible delay, required data rate, or the like. For example, the most time-sensitive packets may be mapped to a first QoS flow 410 that is associated with a relatively low PDB, a relatively high data rate, or a similar parameter; packets that are less time-sensitive may be mapped to a second QoS flow 410 that is associated with a greater PDB and/or a lower data rate or similar parameter; packets that are even less time-sensitive may be mapped to a third QoS flow 410 that is associated with an even greater PDB and/or an even lower data rate or similar parameter, and so forth. As shown by reference number 430, each packet may also be marked with a QoS flow identifier (QFI, sometimes referred to as a 5QI value) associated with the corresponding QoS flow 410 to assist QoS handling by the network node 110, the UE 102, and/or other network components.

As shown at reference number 435, the network node 110 may receive the packets via the various QoS flows 410 and map each packet to a corresponding radio bearer 415, which may be a signaling radio bearer (SRB) or a data radio bearer (DRB). In some aspects, more than one QoS flow 410 may be mapped to a single radio bearer 415. That is, there may not be a one-to-one correlation between the QoS flows 410 and the radio bearers 415. The UE 120 receives the packets via the radio bearers.

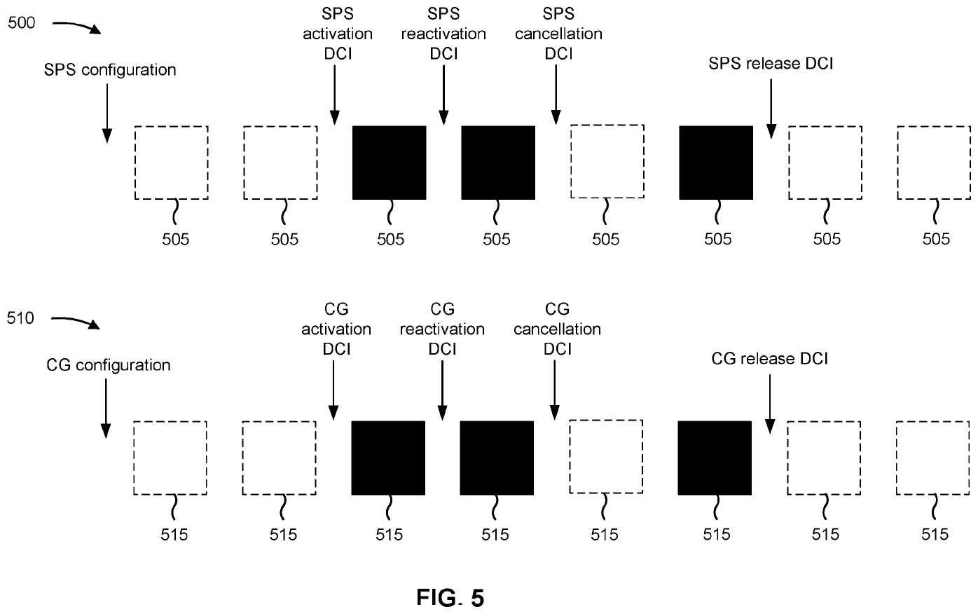

In the uplink (e.g., when sending a transmission from the UE 120 to the network node 110 and ultimately to the core network (e.g., the UPF 405)), the above process is generally performed in reverse. More particularly, as shown by reference number 440, the UE 120 may map packets to be transmitted to QoS flows 410 and/or radio bearers 415. In some aspects, the UE 120 may determine which QoS flow and/or radio bearer to use based at least in part on observing the various QFIs in downlink packets for the PDU session, which provides the UE 120 with information about which packets should be mapped to particular QoS flows and/or radio bearers. In some other aspects, the UE 120 may receive a configuration from the network indicating which QoS flow and/or radio bearer to use for certain packet types, which may be received via RRC signaling or the like. The packets are then transmitted to the network node 110 via the radio bearers 415, and to the UPF 405 via the QoS flows 410, generally in reverse to the process described above. In some aspects described herein, different QoS flows may be associated with transmission occasions of a multi-transmission occasion scheme and/or different QoS flows may be associated with different transmit power levels, as is described in more detail in connection with FIGS. 5-10, below.

As indicated above, FIG. 4 is provided as an example. Other examples may differ from what is described with regard to FIG. 4.

FIG. 5 is a diagram illustrating an example 500 of downlink semi-persistent scheduling (SPS) communication and an example 510 of uplink configured grant (CG) communication, in accordance with the present disclosure. SPS communications may include periodic downlink communications that are configured for a UE 120, such that a network node 110 does not need to transmit (e.g., directly or via one or more network nodes 110) separate downlink communication information (DCI) to schedule each downlink communication, thereby conserving signaling overhead. CG communications may include periodic uplink communications that are configured for a UE 120, such that the network node 110 does not need to transmit (e.g., directly or via one or more network nodes 110) separate DCI to schedule each uplink communication, thereby conserving signaling overhead.

As shown in example 500, a UE 120 may be configured with an SPS configuration for SPS communications. For example, the UE 120 may receive the SPS configuration via an RRC message transmitted by a network node 110 (e.g., directly to the UE 120 or via one or more network nodes 110). The SPS configuration may indicate a resource allocation associated with SPS downlink communications (e.g., in a time domain, frequency domain, spatial domain, and/or code domain) and a periodicity at which the resource allocation is repeated, resulting in periodically reoccurring scheduled SPS occasions 505 for the UE 120. The SPS configuration may also configure hybrid automatic repeat request (HARQ)-acknowledgement (ACK) (HARQ-ACK) feedback resources for the UE 120 to transmit HARQ-ACK feedback for SPS physical downlink shared channel (PDSCH) communications received in the SPS occasions 505. For example, the SPS configuration may indicate a PDSCH-to-HARQ feedback timing value, which may be referred to as a K1 value in a wireless communication standard (e.g., a 3GPP standard).

The network node 110 may transmit SPS activation DCI to the UE 120 (e.g., directly or via one or more network nodes 110) to activate the SPS configuration for the UE 120. The network node 110 may indicate, in the SPS activation DCI, communication parameters, such as an MCS, a resource block (RB) allocation, and/or antenna ports, for the SPS PDSCH communications to be transmitted in the scheduled SPS occasions 505. The UE 120 may begin monitoring the SPS occasions 505 based at least in part on receiving the SPS activation DCI. For example, beginning with a next scheduled SPS occasion 505 subsequent to receiving the SPS activation DCI, the UE 120 may monitor the scheduled SPS occasions 505 to decode PDSCH communications using the communication parameters indicated in the SPS activation DCI. The UE 120 may refrain from monitoring configured SPS occasions 505 prior to receiving the SPS activation DCI.

The network node 110 may transmit SPS reactivation DCI to the UE 120 (e.g., directly or via one or more network nodes) to change the communication parameters for the SPS PDSCH communications. Based at least in part on receiving the SPS reactivation DCI, the UE 120 may begin monitoring the scheduled SPS occasions 505 using the communication parameters indicated in the SPS reactivation DCI. For example, beginning with a next scheduled SPS occasion 505 subsequent to receiving the SPS reactivation DCI, the UE 120 may monitor the scheduled SPS occasions 505 to decode PDSCH communications based on the communication parameters indicated in the SPS reactivation DCI.

In some cases, such as when there is not have downlink traffic to transmit to the UE 120, the network node 110 may transmit SPS cancellation DCI to the UE 120 (e.g., directly or via one or more network nodes 110) to temporarily cancel or deactivate one or more subsequent SPS occasions 505 for the UE 120. The SPS cancellation DCI may deactivate only a subsequent one SPS occasion 505 or a subsequent N SPS occasions 505 (where Nis an integer). SPS occasions 505 after the one or more (e.g., N) SPS occasions 505 subsequent to the SPS cancellation DCI may remain activated. Based at least in part on receiving the SPS cancellation DCI, the UE 120 may refrain from monitoring the one or more (e.g., N) SPS occasions 505 subsequent to receiving the SPS cancellation DCI. As shown in example 500, the SPS cancellation DCI cancels one subsequent SPS occasion 505 for the UE 120. After the SPS occasion 505 (or N SPS occasions) subsequent to receiving the SPS cancellation DCI, the UE 120 may automatically resume monitoring the scheduled SPS occasions 505.

The network node 110 may transmit SPS release DCI to the UE 120 (e.g., directly or via one or more network nodes) to deactivate the SPS configuration for the UE 120. The UE 120 may stop monitoring the scheduled SPS occasions 505 based at least in part on receiving the SPS release DCI. For example, the UE 120 may refrain from monitoring any scheduled SPS occasions 505 until another SPS activation DCI is received by the UE 120. Whereas the SPS cancellation DCI may deactivate only a subsequent one SPS occasion 505 or a subsequent N SPS occasions 505, the SPS release DCI deactivates all subsequent SPS occasions 505 for a given SPS configuration for the UE 120 until the given SPS configuration is activated again by a new SPS activation DCI.

As shown in example 510, a UE 120 may be configured with a CG configuration for CG communications. For example, the UE 120 may receive the CG configuration via an RRC message transmitted by a network node 110 (e.g., directly to the UE or via one or more network nodes 110). The CG configuration may indicate a resource allocation associated with CG uplink communications (e.g., in a time domain, frequency domain, spatial domain, and/or code domain) and a periodicity at which the resource allocation is repeated, resulting in periodically reoccurring scheduled CG occasions 515 for the UE 120. In some examples, the CG configuration may identify a resource pool or multiple resource pools that are available to the UE 120 for an uplink transmission. The CG configuration may configure contention-free CG communications (e.g., where resources are dedicated for the UE 120 to transmit uplink communications) or contention-based CG communications (e.g., where the UE 120 contends for access to a channel in the configured resource allocation, such as by using a channel access procedure or a channel sensing procedure).

The network node 110 may transmit CG activation DCI to the UE 120 (e.g., directly or via one or more network nodes 110) to activate the CG configuration for the UE 120. The network node 110 may indicate, in the CG activation DCI, communication parameters, such as an MCS, an RB allocation, and/or antenna ports, for the CG physical uplink shared channel (PUSCH) communications to be transmitted in the scheduled CG occasions 515. The UE 120 may begin transmitting in the CG occasions 515 based at least in part on receiving the CG activation DCI. For example, beginning with a next scheduled CG occasion 515 subsequent to receiving the CG activation DCI, the UE 120 may transmit a PUSCH communication in the scheduled CG occasions 515 using the communication parameters indicated in the CG activation DCI. The UE 120 may refrain from transmitting in configured CG occasions 515 prior to receiving the CG activation DCI.

The network node 110 may transmit CG reactivation DCI to the UE 120 (e.g., directly or via one or more network nodes) to change the communication parameters for the CG PUSCH communications. Based at least in part on receiving the CG reactivation DCI, and the UE 120 may begin transmitting in the scheduled CG occasions 515 using the communication parameters indicated in the CG reactivation DCI. For example, beginning with a next scheduled CG occasion 515 subsequent to receiving the CG reactivation DCI, the UE 120 may transmit PUSCH communications in the scheduled CG occasions 515 based at least in part on the communication parameters indicated in the CG reactivation DCI.

In some cases, such as when the network node 110 needs to override a scheduled CG communication for a higher priority communication, the network node 110 may transmit CG cancellation DCI to the UE 120 (e.g., directly or via one or more network nodes 110) to temporarily cancel or deactivate one or more subsequent CG occasions 515 for the UE 120. The CG cancellation DCI may deactivate only a subsequent one CG occasion 515 or a subsequent N CG occasions 515 (where Nis an integer). CG occasions 515 after the one or more (e.g., N) CG occasions 515 subsequent to the CG cancellation DCI may remain activated. Based at least in part on receiving the CG cancellation DCI, the UE 120 may refrain from transmitting in the one or more (e.g., N) CG occasions 515 subsequent to receiving the CG cancellation DCI. As shown in example 510, the CG cancellation DCI cancels one subsequent CG occasion 515 for the UE 120. After the CG occasion 515 (or N CG occasions) subsequent to receiving the CG cancellation DCI, the UE 120 may automatically resume transmission in the scheduled CG occasions 515.

The network node 110 may transmit CG release DCI to the UE 120 (e.g., directly or via one or more network nodes) to deactivate the CG configuration for the UE 120. The UE 120 may stop transmitting in the scheduled CG occasions 515 based at least in part on receiving the CG release DCI. For example, the UE 120 may refrain from transmitting in any scheduled CG occasions 515 until another CG activation DCI is received by the UE 120. Whereas the CG cancellation DCI may deactivate only a subsequent one CG occasion 515 or a subsequent N CG occasions 515, the CG release DCI deactivates all subsequent CG occasions 515 for a given CG configuration for the UE 120 until the given CG configuration is activated again by a new CG activation DCI.

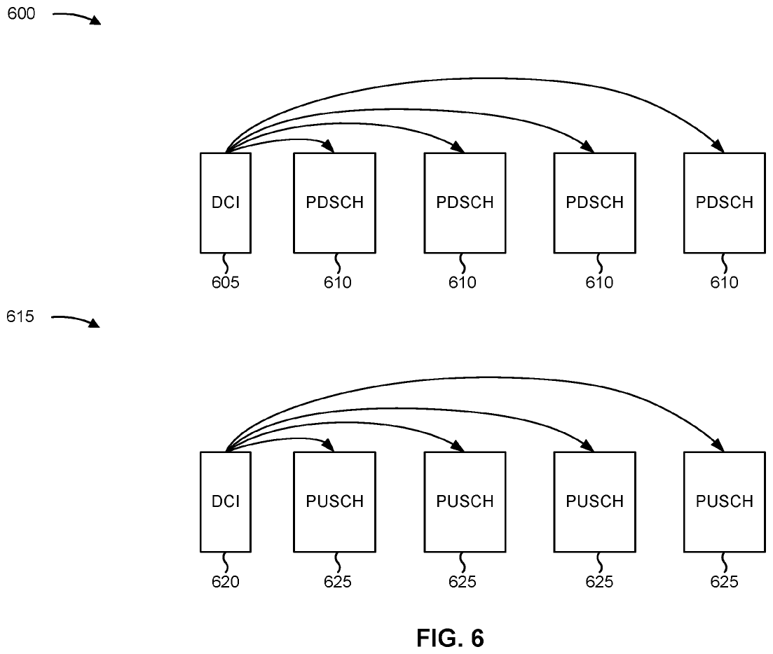

In some cases, instead of, or in addition to, a network node 110 configuring SPS resources for downlink communications and/or CG resources for uplink communications, a network node 110 may conserve signaling overhead in a similar manner as described above by using a single DCI to schedule multiple downlink transmission occasions, such as multiple PDSCHs, and/or by using a single DCI to schedule multiple uplink transmission occasions, such as multiple PUSCHs. Examples of using a single DCI to schedule multiple PDSCHs or multiple PUSCHs are described in more detail in connection with FIG. 6.

As indicated above, FIG. 5 is provided as an example. Other examples may differ from what is described with respect to FIG. 5.

FIG. 6 is a diagram illustrating an example 600 of a DCI communication scheduling multiple downlink communications and an example 615 of a DCI communication scheduling multiple uplink communications, in accordance with the present disclosure. By using a single DCI to schedule multiple downlink communications or multiple uplink communications, a network node 110 does not need to transmit (e.g., directly or via one or more network nodes 110) separate DCI to schedule each downlink communication and/or each uplink communication, thereby conserving signaling overhead.

As shown in example 600, a UE 120 may be scheduled with multiple downlink communications, such as communications associated with multiple PDSCHs, via a single DCI communication. More particularly, the network node 110 may transmit a scheduling DCI 605 to the UE 120 (e.g., directly or via one or more network nodes 110), which indicates multiple forthcoming downlink communications. For example, the scheduling DCI 605 may indicate multiple PDSCH communications 610. The network node 110 may indicate, in the scheduling DCI 605, communication parameters, such as an MCS, an RB allocation, and/or antenna ports for the PDSCH communications 610. The UE 120 may begin monitoring resources associated with the scheduled PDSCH communications 610 based at least in part on receiving the scheduling DCI 605. For example, the UE 120 may monitor the scheduled resources to decode the PDSCH communications 610 using the communication parameters indicated in the scheduling DCI 605.

As shown in example 615, a UE 120 may be scheduled with multiple uplink communications, such as communications associated with multiple PUSCHs, via a single DCI communication. More particularly, the network node 110 may transmit a scheduling DCI 620 to the UE 120 (e.g., directly or via one or more network nodes 110), which indicates multiple forthcoming uplink communications. For example, the scheduling DCI 620 may indicate multiple PUSCH communications 625. The network node 110 may indicate, in the scheduling DCI 620, communication parameters, such as an MCS, an RB allocation, and/or antenna ports for the PUSCH communications 625. The UE 120 may begin transmitting in resources associated with the scheduled PUSCH communications 625 based at least in part on receiving the scheduling DCI 620. For example, the UE 120 may transmit the PUSCH communications 625 using the communication parameters indicated in the scheduling DCI 620.

In some cases, an uplink or a downlink communication may be transmitted using multiple occasions associated with the SPS resources or CG resources described in connection with FIG. 5, or with the multiple PDSCH communications 610 or PUSCH communications 625 described in connection with FIG. 6. For example, an extended reality (XR) related transmission may be associated with a data unit, sometimes referred to as an application data unit (ADU) and/or a PDU set, that is larger than an internet protocol (IP) packet size. The ADU and/or the PDU set may thus be segmented into IP packets (e.g., PDUs) for transmission in the uplink or downlink. In some instances, the segmented packets may be transmitted using SPS resources, CG resources, multiple PDSCHs scheduled by a single DCI, or multiple PUSCHs scheduled by a DCI. For example, each PDU associated with a PDU set may be transmitted in a corresponding SPS occasion, a corresponding CG occasion, a corresponding PDSCH associated with multiple PDSCHs scheduled by a single DCI, or a corresponding PUSCH associated with multiple PUSCHs scheduled by a single DCI. The corresponding SPS occasions, CG occasions, PDSCHs associated with multiple PDSCHs scheduled by a single DCI, and/or PUSCHs associated with multiple PUSCHs scheduled by a single DCI may be referred to herein as transmission occasions.

Moreover, XR-related transmissions may be quasi-periodic and associated with low latency and high reliability requirements. Accordingly, XR-related transmissions may be associated with limited PDBs. This may be problematic for a PDU set transmitted across multiple transmission occasions, because PDUs transmitted in transmission occasions very near to the PDB deadline may be unable to be retransmitted without exceeding the PDB. Put another way, if a PDU that is transmitted by a wireless communication device (e.g., a network node 110 or a UE 120) in a transmission occasion near the PDB deadline is not safely received by another wireless communication device, the PDU may not be able to be retransmitted because the PDB may expire prior to the retransmission, and thus the entire XR packet (e.g., PDB set) may not be safely received and decoded. Accordingly, a PDU set transmitted using SPS resources, CG resources, multiple PDSCHs scheduled by a single DCI, or multiple PUSCHs scheduled by a DCI may experience a high transmission error rate, leading to disrupted communications; high power, network, and computing resource consumption associated with error correction procedures; inefficient usage of network resources; and overall unreliable XR communications.

Some techniques and apparatuses described herein enable a PDU set to be transmitted using SPS resources, CG resources, multiple PDSCHs scheduled by a single DCI, or multiple PUSCHs scheduled by a DCI. More particularly, in some aspects, a transmit power associated with a PDU set may be increased for PDUs transmitted near a PDB deadline and/or for high priority PDUs. For example, in some aspects, a wireless communication device may increase a transmit power associated with a PDU set once a configured time threshold has elapsed. Additionally, or alternatively, a wireless communication device may increase a transmit power associated with a PDU set when transmitting high priority PDUs, such as an intra-coded frame (I-frame) of a video compression process. In that regard, a constant MCS may be utilized across all transmission occasions associated with a PDU set while reducing the probability of retransmission for certain PDUs in the PDU set (e.g., PDUs transmitted near the PDB deadline and/or associated with high priority transmissions). In some aspects, a network node 110 may configure a UE 120 with various transmit power levels and/or signal to the UE 120 various transmit power levels that should be utilized when transmitting a PDU set. Increasing a transmit power associated with PDUs transmitted near a PDB deadline and/or increasing a transmit power associated with high priority PDUs may reduce the probability of retransmissions, resulting in less disrupted communications; reduced power, network, and computing resource consumption associated with error correction procedures; more efficient usage of network resources; and overall more reliable XR communications.

As indicated above, FIG. 6 is provided as an example. Other examples may differ from what is described with respect to FIG. 6.

FIG. 7 is a diagram illustrating an example 700 and an example 710 associated with power control for multi-transmission scheduling, in accordance with the present disclosure. The example 700 and the example 710 shown in FIG. 7 may be associated with wireless communication between two wireless communication devices, such as a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

As described above, XR-related traffic and similar transmissions may be associated with a PDU set that is segmented into multiple IP packets and/or PDUs for transmission. PDUs belonging to the same PDU set may be transmitted on multiple SPS occasions, multiple CG occasions, multiple PDSCHs scheduled by one DCI, or multiple PUSCHs scheduled by one DCI. In some aspects, a transmit power associated with data belonging to the same PDU set may be increased as a PDU set transmission approaches a PDB deadline. More particularly, as the transmission approaches the PDB deadline, there may not be enough time for PDUs to be retransmitted prior to expiration of the PDB if any PDUs are not safely received and decoded. Thus, the transmit power may be increased for PDUs near the PDB deadline in order to enhance the transmission reliability and thus reduce the probability of retransmission. In some aspects, increasing a transmit power associated with PDUs transmitted near the PDB deadline may also beneficially permit all PDUs of a PDU set to be transmitted using the same MCS. Put another way, to support and guarantee an MCS level for the later PDUs approaching the PDB deadline, the transmit power may be increased because retransmission of the later PDUs may not be permitted, as described.

Additionally, or alternatively, in some aspects, different transmit power levels may be associated with different QoS flows and/or different priority traffic. For example, multiple transmit powers may be used for XR-related data transmission associated with a video compression process, or the like. A video compression process may be associated with different types of video frames, such as an I-frame, a predicted frame (P-frame), or a bidirectional predicted frame (B-frame). An I-frame may be associated with a highest priority and/or QoS flow, because the I-frame is the least compressible of the frame types and does not require other video frames to decode. A P-frame or a B-frame may be associated with a lower priority and/or QoS flow than the I-frame because the frames are more compressible than I-frames and use data from other frames during a decompression process. Accordingly, in some aspects, a high transmit power may be associated with a high QoS-required flow (e.g., a QoS flow associated with an I-frame), and a lower transmit power may be associated with a low QoS-required flow (e.g., a QoS flow associated with a P-frame or a B-frame).

As shown by examples 700 and 710, in some aspects a transmit power associated with transmission of a PDU set may be increased after a configured time threshold has elapsed. In these examples, a PDU set may be transmitted by a wireless communication device (e.g., a UE 120 or a network node 110) using multiple transmission occasions. For example, as shown by example 700, a PDU set may be transmitted using multiple transmission occasions 705, which may be associated with SPS resources when the PDU set is transmitted in the downlink (e.g., which may be multiple PDSCHs associated with an SPS configuration), or which may be associated with CG resources when the PDU set is transmitted in the uplink (e.g., which may be multiple PUSCHs associated with a CG configuration). Alternatively, as shown by example 710, a PDU set may be transmitted using multiple transmission occasions 715 scheduled by one scheduling DCI 720. For example, the multiple transmission occasions 715 may be multiple PDSCHs scheduled by the scheduling DCI 720 when the PDU set is transmitted in the downlink, or the multiple transmission occasions 715 may be multiple PUSCHs scheduled by the scheduling DCI 720 when the PDU set is transmitted in the uplink.

In examples 700 and 710, a transmit power associated with the PDU set may be increased when PDUs of the PDU set surpass the configured time threshold, which, in some aspects, may be near to a PDB deadline. More particularly, the final two transmission occasions 705 in example 700 and the final two transmission occasions 715 in example 710 occur after the configured time threshold. Accordingly, a wireless communication device transmitting the PDU set (e.g., a network node 110 in the downlink or a UE 120 in the uplink) may transmit the first four transmission occasions 705, 715 associated with a PDU set using a first transmit power (e.g., a low transmit power), and may transmit the final two transmission occasions 705, 715 associated with the PDU set using a second transmit power different from the first transmit power (e.g., a high transmit power).

In some aspects, the configured time threshold may be associated with a number of transmission occasions (e.g., a number of PUSCHs and/or PDSCHs), such as, in the depicted examples 700, 710, four transmission occasions 705, 715. Additionally, or alternatively, the configured time threshold may be associated with a number of slots after the first transmission occasion 705, 715 (e.g., after the first PUSCH or PDSCH). In some aspects, the configured time threshold may be configured by a network node 110 or another network device via an RRC communication. For example, the configured time threshold may be configured by a network node 110 in an RRC communication that includes a CG configuration, or the configured time threshold may be configured by a network node 110 in an RRC communication that includes a configuration of multiple PUSCH resources.

Moreover, in some aspects, a reference time and/or a start time associated with the configured time threshold may be associated with a first slot associated with a first transmission occasion 715 scheduled by the scheduling DCI 720 (e.g., a first PDSCH or PUSCH of multiple PDSCHs or PUSCHs scheduled by one DCI), or else a first slot associated with a first transmission occasion 705 associated with an SPS configuration or a CG configuration (e.g., a first PDSCH associated with an SPS configuration or a first PUSCH associated with a CG configuration). In some other aspects, a reference time and/or a start time associated with the configured time threshold may be associated with another configured timer, such as a start of a connected mode discontinuous reception (CDRX) timer, or a similar timer. In some aspects, when a PDU set transmission arrives at the configured time threshold, the transmitting wireless communication device (e.g., the UE 120 or the network node 110) may automatically increase a transmit power level from a first transmit power level (e.g., a low transmit power level) to a second transmit power level (e.g., a high transmit power level).

In some aspects, a data association identifier may be used to associate multiple transmission occasions 705, 715 with a single PDU set. For example, in some aspects, data transmissions sharing the same data association identifier may belong to the same video frame and thus the same PDU set. In some aspects, a wireless communication device (e.g., a network node 110 or a UE 120) may decide whether the configured time threshold has elapsed with respect to transmission occasions 705, 715 sharing the same data association identifier. In some aspects, a network node 110 may transmit, to a UE 120, an indication of a data association identifier associated with a set of transmission occasions 705, 715. For example, in some aspects, a network node 110 may indicate a data association identifier associated with a set of transmission occasions 705, 715 in the scheduling DCI 720, in configuration information associated with a configuration of SPS or CG resources (such as in an RRC communication or a medium access control (MAC) control element (MAC-CE) communication), and/or the in an activation DCI associated with an SPS configuration or a CG configuration.

In some aspects, instead of, or in addition to, adjusting a transmit power level based at least in part on a configured time threshold, a wireless communication device may adjust a transmit power level according to a power transmit formula. Moreover, in some aspects, the power transmit formula may be based at least in part on one or more power transmit parameters associated with a PDB associated with a PDU set, or the like. For example, a wireless communication device (e.g., a UE 120) may adjust a transmit power level based at least in part on the formula P_{PUSCH}(j, q, l)=min{P_{CMAX}, P_{O_PUSCH}(j)+10·log₁₀(2^{μ}·M_{RB}^{PUSCH})+α(j)·PL(q)+Δ_{TF}+f(l)}, sometimes referred to as an uplink power control equation, in which P_{CMAX} corresponds to the UE configured maximum output power; and in which P_{O_PUSCH}(j), μ, M_{RB}^{PUSCH}, α(j), PL(q), Δ_{TF}, and f(l) correspond to the variables defined in section 7.1.1 of Technical Specification (TS) 38.213 promulgated by the 3GPP. In that regard, in some aspects, f(l) (sometimes referred to as a power control adjustment state) may be based at least in part on transmit power control (TPC) command value, δ_{PUSCH}. In some aspects, one or more of P_{CMAX}, P_{O_PUSCH} (j), or δ_{PUSCH} may be modified and/or configured for different transmission occasions 705, 715 such that a transmit power increases for transmission occasions 705, 715 occurring near to a PDB and/or for high priority transmissions, or the like. In some aspects, the closer a particular transmission occasion 705, 715 is to the PDB deadline, the larger a transmit power level becomes until a maximum permitted transmission power of a UE (e.g., P_{CMAX}) is reached.

In some aspects, a value of the TPC command value δ_{PUSCH} may be based at least in part on a table, such as the Table 7.1.1-1 of section 7.1.1 of TS 38.213. In some aspects, the table associated with the TPC command value δ_{PUSCH} may be extended to support specific QoS-related XR-related flows, or the like. For example, a table associated with the TPC command value δ_{PUSCH} may be extended to include TPC command values δ_{PUSCH} that are based at least in part on a PDB associated with a PDU set. Accordingly, such TPC command values δ_{PUSCH}, when inputted into the above described uplink power control equation, may result in increased transmit power levels for PDUs occurring nearer to a PDB deadline, or the like. In some aspects, a network node 110 may indicate one or more TPC command values δ_{PUSCH} to be used in connection with the uplink power control equation using a DCI communication, such as by using TPC command field associated with one of a DCI format 2_2 communication or a DCI format 2_3 communication.

In some aspects, PDUs associated with the same PDU set (e.g., the same XR-related data transmission) may be associated with meta data or the like indicating a transmit power configuration and/or pattern to be applied to a PDU set. For example, in some aspects, multiple PDUs associated with a PDU set may be associated with ADU meta data (AMD), which may be observed by a RAN component of a UE 120 and/or a network node 110. In such aspects, the AMD may indicate a QoS requirement associated with the PDU set, a transmit power control configuration and/or pattern associated with the PDU set, or similar power control information. In some aspects, the AMD may indicate that a transmit power level should be adaptively controlled. For example, when PDUs associated with a PDU set associated with AMD surpass the configured time threshold shown in FIG. 7, a wireless communication device may increase the transmit power level from a first transmit power level (e.g., a low transmit power level) to a second transmit power level (e.g., a high transmit power level), in a similar manner as described above in connection with examples 700 and 710. In some other aspects, the AMD may indicate that an entire PDU set is associated with a high priority communication or the like, and thus a wireless communication device may transmit the entire PDU set using a relatively high transmit power level. Put another way, in some aspects, the AMD may indicate that all the transmission occasions 705, 715 associated with a particular PDU set should be transmitted using a high transmit power level, such as for when transmitting an I-frame or the like.

In some aspects, a UE 120 may recommend to a network node 110 an initial transmit power level to be used for a PDU set transmission, and/or otherwise indicate transmit-power-level-related information to a network node 110, using uplink control signaling, or the like. For example, a UE 120 may signal transmit-power-level-related information to a network node 110 using an uplink control information (UCI) communication, or a similar communication. More particularly, in aspects in which a PDU set transmission is associated with a UCI-aided CG configuration (e.g., a configuration of CG resources that is based at least in part on information provided to the network node 110 by the UE 120 via UCI), a UCI communication associated with the UCI-aided CG configuration may include information suggesting an initial transmit power level to be utilized, or the like. Based at least in part on the information contained in the UCI message, the network node 110 may configure one or more transmit power levels to be used by the UE 120, such as by using an RRC communication and/or a MAC-CE communication in the case of a CG-based PDU set transmission, and/or the network node 110 may indicate one or more transmit power levels to be used by the UE 120 via a DCI communication. In some aspects, the network node 110 may indicate the one or more transmit power levels to be used by the UE 120 via an activation DCI communication that activates a CG configuration, such as the activation DCI described in connection with FIG. 5. In some aspects, a UCI communication or the like may be used to indicate additional parameters or information associated with a PDU set transmission, such as to indicate an MCS to be used for the PDU set transmission, or the like.

As indicated above, FIG. 7 is provided as an example. Other examples may differ from what is described with respect to FIG. 7.

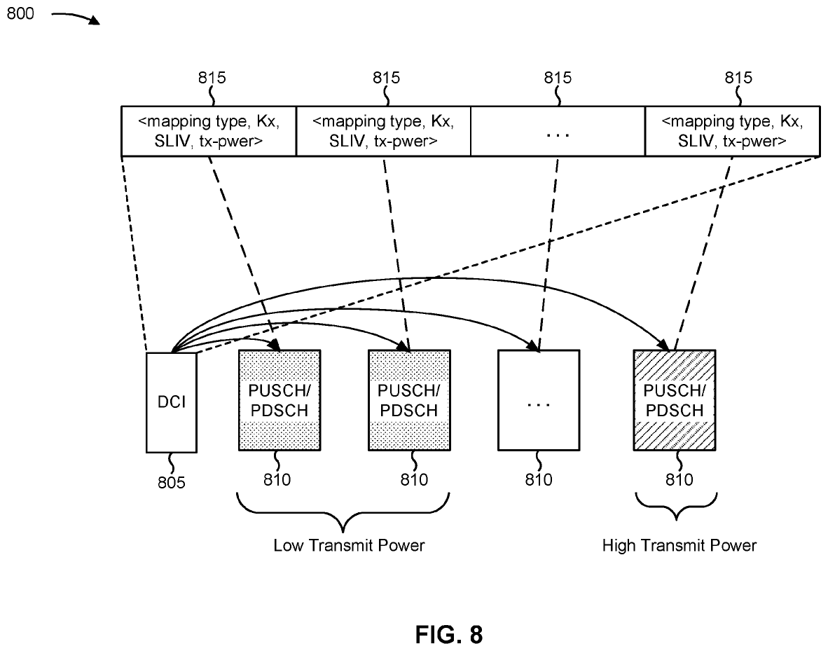

FIG. 8 is a diagram illustrating another example 800 associated with power control for multi-transmission scheduling, in accordance with the present disclosure. The example 800 shown in FIG. 8 may be associated with wireless communication between two wireless communication devices, such as a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

In the example 800 shown in FIG. 8, a single DCI (e.g., a scheduling DCI 805) is used to schedule multiple transmission occasions 810 (e.g., multiple PUSCHs used by a UE 120 to transmit a PDU set or multiple PDSCHs used by a network node 110 to transmit a PDU set). In that regard, the scheduling DCI 805 may be similar to the scheduling DCI 720 described in connection with FIG. 7. In some aspects, the scheduling DCI 805 may further be used to indicate transmit power levels associated with transmission occasions 810 associated with the PDU set transmission. For example, the scheduling DCI 805 may separately indicate a transmit power level associated with a first transmission occasion 810 (e.g., a first PUSCH or PUSCH), a transmit power level associated with a second transmission occasion 810 (e.g., a second PUSCH or PUSCH), a transmit power level associated with a third transmission occasion 810 (e.g., a third PUSCH or PUSCH), and so forth.

In some aspects, an indication associated with a time domain resource allocation (TDRA) may be used to indicate a transmit power level associated with each transmission occasion 810. For example, the scheduling DCI 805 may include a TDRA field, which indicates a TDRA table entry (e.g., a row of a TDRA table) associated with a PDU set transmission. For each scheduled transmission occasion 810, the TDRA table entry may include a corresponding combination of parameters, such as a mapping type indicator (sometimes referred to as “mapping type”), one or more offset parameters (such as a K0 parameter, a K2 parameter, or the like, sometimes generically referred to as “Kx”), a start and length indicator (sometimes referred to as “SLIV”), and/or a power transmit level indication (sometimes referred to “tx-pwer”). Put another way, the TDRA table entry may include multiple TDRA parameter combination entries 815 indicating {mapping type, SLIV, Kx, tx-pwer}, with each one of the TDRA parameter combination entries 815 corresponding to a scheduled transmission occasion 810. In the example shown in FIG. 8, at least the first two transmission occasions 810 are transmitted using a first transmit power level (e.g., a low transmit power level) and at least the final transmission occasion 810 is transmitted using a second transmit power level (e.g., a high transmit power level). Accordingly, a power transmit level indication (e.g., tx-pwer) included in a TDRA parameter combination entry 815 (e.g., {mapping type, SLIV, Kx, tx-pwer}) associated with each of the first two transmission occasions 810 may indicate that a first transmit power level should be used, and a power transmit level indication (e.g., tx-pwer) included in a TDRA parameter combination entry 815 (e.g., {mapping type, SLIV, Kx, tx-pwer}) associated with the final two transmission occasion 810 may indicate that a second transmit power level different from the first transmit power level should be used.

In some aspects, other DCI communications (e.g., DCI communications instead of, or in addition to, the scheduling DCI 805) may be used to indicate a corresponding transmit power level for one or more transmission occasions 810. For example, a network node 110 may indicate that a transmit power level should be adjusted or otherwise reconfigured using a reactivation DCI or the like, such as one of the reactivation DCI communications described above in connection with examples 500 and 510. In some aspects, a network node 110 may be associated with a PDU threshold or the like, and, based at least in part on receiving a threshold number of PDUs, the network node 110 may transmit, to the UE 120, a reactivation DCI indicating that a transmit power level should be increased for any remaining PDUs associated with a PDU set (e.g., any remaining transmission occasions associated with a PDU set transmission). Put another way, after receiving a certain number of packets (e.g., PDUs) belonging to the same PDU set, the network node 110 may indicate to the UE 120, using a reactivation DCI, to increase a transmit power level for any remaining packets because the remaining packets may be transmitted close to a PDB deadline and thus may not be able to be retransmitted if the packets are not safely received and decoded.

In some aspects, a network node 110 may transmit a reactivation DCI indicating that a transmit power level should be increased for any remaining PDUs associated with a PDU set based at least in part on a packet latency of one or more received PDUs of the PDU set. More particularly, based at least in part on the network node 110 determining that received PDUs are associated with a relatively high latency, the network node 110 may transmit, to the UE 120, a reactivation DCI indicating that the transmit power level should be increased. Put another way, a network node 110 may determine that a packet transmission latency has surpassed a specific latency threshold, and, in response, may signal to the UE 120, using a reactivation DCI, that a transmit power level associated with any remaining packets should be increased. In some aspects, the reactivation DCI may indicate an amount that an initial transmit power level should be increased (e.g., the reactivation DCI may indicate a transmit power differential between the current or initial transmit power level and a target transmit power level), while, in some other aspects, the reactivation DCI may indicate the target transmit power that should be used for any remaining packets.

In some aspects, a UE 120 may be configured with multiple transmit power patterns, and a network node 110 may signal, to the UE 120, a selected transmit power pattern to be implemented based at least in part on a type of data transmission being transmitted, a required QoS flow and/or PDB for the data transmission, or the like. For example, the network node 110 may configure the UE 120 with multiple transmit power patterns via an RRC communication, a MAC-CE communication, or the like. The transmit power patterns may indicate various transmit power levels associated with a PDU set, such as indicating an increase in a transmit power level as the PDU set approaches a PDB deadline, an increase in a transmit power level for certain high priority packets, or the like. Additionally, or alternatively, the network node 110 may indicate which of the multiple transmit power patterns should be used for a given transmission, such as via a DCI communication. That is, in some aspects, a particular transmit power pattern may be activated and/or deactivated using DCI. In some aspects, the DCI communication may indicate a transmit power pattern to be used for a PDU set by mapping a selected transmit power pattern to an AMD indicator associated with the PDU set, or the like.

In some aspects, a wireless communication device may adjust a transmit power level associated with a PDU set based at least in part on one or more measurements performed by the UE 120. For example, the UE 120 may measure channel state information (CSI) during a period in which the UE 120 is transmitting a PDU set. More particularly, while transmitting a PDU set using CG resources or multiple PUSCHs scheduled by a single DCI, the UE 120 may receive, from the network node 110, one or more reference signals (e.g., one or more CSI reference signals (CSI-RSs)) in a PDSCH in a downlink slot, or the like. The UE 120 may measure the one or more reference signals, and may adjust a transmit power level based at least in part on the measurements. For example, the measurements may indicate that a downlink channel is degrading, such as when it becomes difficult for the UE 120 to decode the one or more reference signals (e.g., the one or more CSI-RSs) and/or when a latency associated with the one or more reference signals is increasing. Because a quality of the downlink channel may be associated with the quality of the uplink channel, such measurements may indicate a degrading uplink channel as well, and thus the UE 120 may increase a transmit power level for any remaining PDUs of the PDU set to compensate for the degrading channel.

Additionally, or alternatively, the UE 120 may increase a transmit power level for certain PDUs of a PDU set based at least in part on feedback received from the network node 110 or other network entity, such as negative acknowledgement (NACK) feedback received as part of a HARQ process, or the like. For example, when transmitting in an unlicensed frequency band, such as an NR unlicensed (NR-U) band, the UE 120 may adjust a transmit power level based at least in part on a number of NACK communications received from a receiver terminal, or the like. In some aspects, the UE 120 may be configured with a NACK threshold (sometimes referred to as T_nack), and the UE 120 may increase a transmit power for a PDU set when a number of received NACK communications for the PDU set exceeds the NACK threshold. Additionally, or alternatively, in some aspects, the UE 120 may be configured with a power adjustment step (sometimes referred to as S_p), and based at least in part on the UE 120 receiving a NACK communication for a PDU associated with a PDU set, the UE 120 may increase a transmit power level associated with a retransmission of the PDU and/or for any remaining PDUs of the PDU set by the power adjustment step (e.g., S_p). In some aspects, the UE 120 may be configured with a maximum transmit power level (sometimes referred to as P_max). Accordingly, when adjusting the transmit power level (such as by S_p or the like) would result in a transmit power level that exceed the maximum transmit power level (e.g., P_max), the UE 120 may instead retransmit any PDUs and/or transmit any remaining PDUs using the maximum transmit power level. In some aspects, once a PDU set has been fully transmitted, the UE 120 may revert to an initial transmit power level (e.g., an initial configured value for the transmit power level) for transmitting any subsequent PDU sets.

As indicated above, FIG. 8 is provided as an example. Other examples may differ from what is described with respect to FIG. 8.

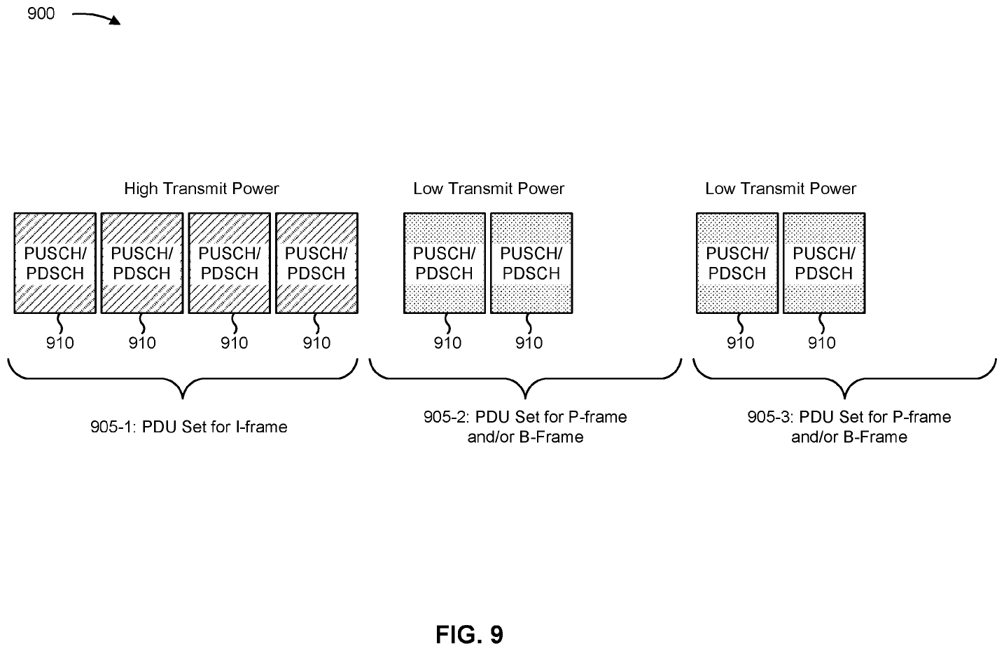

FIG. 9 is a diagram illustrating another example 900 associated with power control for multi-transmission scheduling, in accordance with the present disclosure. The example 900 shown in FIG. 9 may be associated with wireless communication between two wireless communication devices, such as a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

In some aspects, a transmit power level may be adjusted (e.g., increased) for entire PDU sets, such as high priority PDU sets, with respect to other PDU sets. For example, for video frame data transmission (e.g., a group of pictures (GOP) based video transmission), an I-frame associated with a video compression process may be associated with a higher priority than a P-frame and/or a B-frame, as described above. Accordingly, a PDU set carrying an I-frame may be transmitted with a higher transmit power level than a PDU set carrying a P-frame and/or a B-frame. For example, FIG. 9 shows three PDU sets 905-1, 905-2, 905-3 transmitted by a wireless communication device (e.g., one of a UE 120 or a network node 110), each including multiple transmission occasions 910. In this aspect, the first PDU set 905-1 may be associated with transmission of an I-frame, while the second PDU set 905-2 and the third PDU set 905-3 may be each associated with transmission of one of a P-frame or a B-frame. In that regard, the first PDU set 905-1 may require the use of more transmission occasions 910 than the second PDU set 905-2 and/or the third PDU set 905-3, because an I-frame may contain more data than a P-frame and/or a B-frame.

Moreover, in this aspect, the I-frame may be transmitted using a different transmit power level than the P-frame and/or the B-frame. For example, the I-frame (e.g., PDU set 905-1) may be transmitted using a relatively high transmit power level (e.g., each of the PDUs within the first PDU set 905-1 may be transmitted using a high transmit power level) and the P-frames and/or the B-frames may be transmitted using a relatively low transmit power level (e.g., each of the PDUs within the second PDU set 905-2 and/or within the third PDU set 905-3 may be transmitted using a low transmit power level).

In some aspects, the transmission occasions 910 shown in FIG. 9 may be associated with an SPS configuration. In such aspects, a configuration of a transmit power pattern (e.g., a pattern corresponding to the transmit power levels shown in connection with the three PDU sets 905-1, 905-2, 905-3, such as a high transmit power for a first PDU set 905-1 followed by a low transmit power level for the remaining two PDU sets 905-2, 905-3) may be based at least in part on certain SPS parameters or the like. In some aspects, a configured periodicity associated with a transmit power pattern (sometimes referred to as N) may be associated with a number of SPS occasions. For example, for a GOP transmission with twelve frames, including one I-frame and 11 P-frames or B-frames, a periodicity associated with a transmit power pattern (e.g., N) may be equal to twelve (e.g., twelve SPS occasions may be used for transmitting the GOP transmission). Additionally, or alternatively, a UE 120 may be configured with an occasion offset, which may indicate a starting SPS occasion for a GOP transmission (e.g., the occasion offset may indicate an SPS occasion to be used for transmitting an I-frame). Moreover, as described above in connection with the three PDU sets 905-1, 905-2, 905-3, separate transmit power levels may be configured for occasions within an SPS period (e.g., within multiple SPS occasions associated with the periodicity, N). For example, in the example in which the GOP transmission includes twelve frames (e.g., N=12), the configuration may indicate that a high transmit power level should be used for an SPS occasion occurring at the configured occasion offset (e.g., a first SPS occasion to be used for transmission) as well as SPS occasions occurring at the configured occasion offset plus the periodicity associated with a transmit power pattern (e.g., N), which may correspond to PDU sets carrying I-frames, and/or the configuration may indicate that a low transmit power level should be used for all other SPS occasions.

Based at least in part on the UE 120 and/or the network node 110 increasing a transmit power level for PDUs within a PDU set and/or increasing a transmit power level for certain PDU sets (e.g., high priority PDU sets), the UE 120 and/or the network node 110 may conserve computing, power, network, and/or communication resources that may have otherwise been consumed transmitting all PDUs within a PDU set using a constant transmit power level and/or transmitting all PDU sets using a constant transmit power level. For example, based at least in part on UE 120 and/or the network node 110 increasing a transmit power level for PDUs within a PDU set and/or increasing a transmit power level for certain PDU sets (e.g., high priority PDU sets), the UE 120 and the network node 110 may communicate with a reduced error rate, which may conserve computing, power, network, and/or communication resources that may have otherwise been consumed to detect and/or correct communication errors. Additionally, or alternatively, based at least in part on UE 120 and/or the network node 110 increasing a transmit power level for PDUs within a PDU set and/or increasing a transmit power level for certain PDU sets (e.g., high priority PDU sets), the UE 120 and/or the network node 110 may reduce the probability of retransmissions, resulting in less disrupted communications; reduced power, network, and computing resource consumption associated with error correction procedures; more efficient usage of network resources; and overall more reliable XR communications.

As indicated above, FIG. 9 is provided as an example. Other examples may differ from what is described with respect to FIG. 9.

FIG. 10 is a diagram illustrating an example process 1000 performed, for example, by a UE, in accordance with the present disclosure. Example process 1000 is an example where the UE (e.g., UE 120) performs operations associated with power control for multi-transmission scheduling.

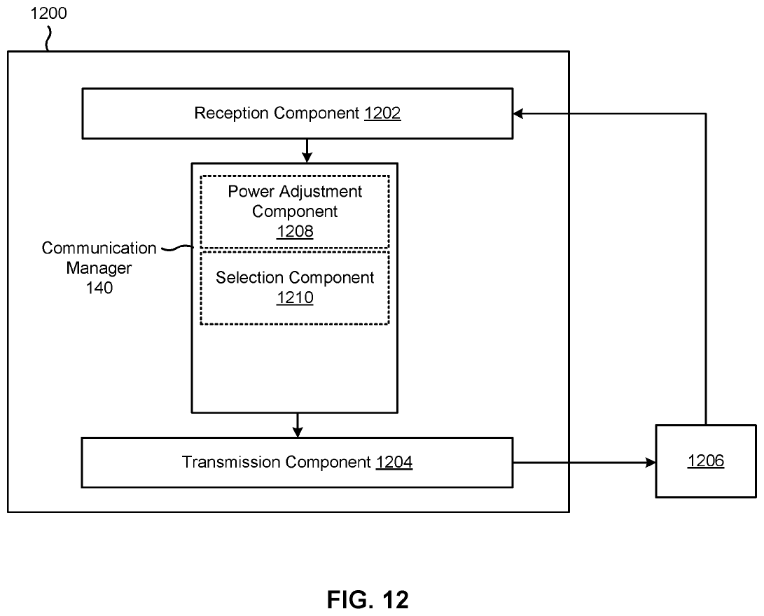

As shown in FIG. 10, in some aspects, process 1000 may include receiving a configuration of transmission resources, wherein the transmission resources are associated with multiple transmission occasions associated with a PDU set (block 1010). For example, the UE (e.g., using communication manager 140 and/or reception component 1202, depicted in FIG. 12) may receive a configuration of transmission resources, wherein the transmission resources are associated with multiple transmission occasions associated with a PDU set, as described above.

As further shown in FIG. 10, in some aspects, process 1000 may include transmitting or receiving the PDU set by: transmitting or receiving a first subset of one or more PDUs, of the PDU set, using a first subset of one or more transmission occasions, of the multiple transmission occasions, wherein the first subset of one or more PDUs is associated with a first transmit power; and transmitting or receiving a second subset of one or more PDUs, of the PDU set, using a second subset of one or more transmission occasions, of the multiple transmission occasions, wherein the second subset of one or more PDUs is associated with a second transmit power different than the first transmit power (block 1020). For example, the UE (e.g., using communication manager 140, reception component 1202, and/or transmission component 1204, depicted in FIG. 12) may transmit or receive the PDU set by: transmitting or receiving a first subset of one or more PDUs, of the PDU set, using a first subset of one or more transmission occasions, of the multiple transmission occasions, wherein the first subset of one or more PDUs is associated with a first transmit power; and transmitting or receiving a second subset of one or more PDUs, of the PDU set, using a second subset of one or more transmission occasions, of the multiple transmission occasions, wherein the second subset of one or more PDUs is associated with a second transmit power different than the first transmit power, as described above.

Process 1000 may include additional aspects, such as any single aspect or any combination of aspects described below and/or in connection with one or more other processes described elsewhere herein.

In a first aspect, the PDU set is associated with an extended reality communication.

In a second aspect, alone or in combination with the first aspect, the multiple transmission occasions are associated with one of configured grant resources, multiple physical uplink shared channel resources scheduled by one DCI communication, semi-persistent scheduled resources, or multiple physical downlink shared channel resources scheduled by one DCI communication.

In a third aspect, alone or in combination with one or more of the first and second aspects, the PDU set is associated with a PDB, the second subset of transmission occasions occurs nearer to expiration of the PDB than the first subset of transmission occasions, and the second transmit power is higher than the first transmit power.

In a fourth aspect, alone or in combination with one or more of the first through third aspects, the first subset of PDUs is associated with an I-frame associated with a compression process, and the second subset of PDUs is associated with one of a P-frame or a B-frame associated with the compression process.

In a fifth aspect, alone or in combination with one or more of the first through fourth aspects, the I-frame is associated with a higher transmit power than the one of the P-frame or the B-frame.

In a sixth aspect, alone or in combination with one or more of the first through fifth aspects, the first subset of PDUs and the second subset of PDUs are transmitted or received using a same modulation and coding scheme index.

In a seventh aspect, alone or in combination with one or more of the first through sixth aspects, the first subset of PDUs is associated with a first QoS flow, and the second subset of PDUs is associated with a second QoS flow having a higher priority than the first QoS flow.

In an eighth aspect, alone or in combination with one or more of the first through seventh aspects, process 1000 includes receiving an indication of the first transmit power and the second transmit power.

In a ninth aspect, alone or in combination with one or more of the first through eighth aspects, the indication of the first transmit power and the second transmit power is received in a single downlink control information communication.

In a tenth aspect, alone or in combination with one or more of the first through ninth aspects, process 1000 includes receiving a configuration of a configured time threshold, wherein the first subset of PDUs is transmitted or received prior to expiration of the configured time threshold, wherein the second subset of PDUs is transmitted or received after expiration of the configured time threshold, and wherein the second transmit power is higher than the first transmit power.

In an eleventh aspect, alone or in combination with one or more of the first through tenth aspects, the configured time threshold is associated with one of a number of transmission occasions, of the multiple transmission occasions, or a number of slots after a first transmission occasion, of the multiple transmission occasions.

In a twelfth aspect, alone or in combination with one or more of the first through eleventh aspects, the configuration of the configured time threshold is received via a radio resource control communication.

In a thirteenth aspect, alone or in combination with one or more of the first through twelfth aspects, a start time associated with the configured time threshold is associated with one of a slot associated with a first transmission occasion, of the multiple transmission occasions, or a start of a connected mode discontinuous reception timer.

In a fourteenth aspect, alone or in combination with one or more of the first through thirteenth aspects, process 1000 includes increasing a transmit power from the first transmit power to the second transmit power based at least in part on an expiration of the configured time threshold.

In a fifteenth aspect, alone or in combination with one or more of the first through fourteenth aspects, the multiple transmission occasions are associated with PUSCH resources associated with a same data association identifier, and the configured time threshold is associated with the PUSCH resources associated with the same data association identifier.

In a sixteenth aspect, alone or in combination with one or more of the first through fifteenth aspects, the data association identifier is indicated by one of a scheduling DCI communication associated with the multiple transmission occasions, a CG configuration included in one of a radio resource control communication or a MAC-CE communication, or an activation DCI communication activating the CG configuration.

In a seventeenth aspect, alone or in combination with one or more of the first through sixteenth aspects, process 1000 includes adjusting a transmit power from the first transmit power to the second transmit power based at least in part on one or more configured power transmit parameters associated with a power transmit formula.

In an eighteenth aspect, alone or in combination with one or more of the first through seventeenth aspects, process 1000 includes adjusting the transmit power from the second transmit power to a maximum permitted transmit power based at least in part on the one or more configured power transmit parameters associated with the power transmit formula.

In a nineteenth aspect, alone or in combination with one or more of the first through eighteenth aspects, process 1000 includes adjusting a transmit power from the first transmit power to the second transmit power based at least in part on a power adjustment parameter indicated by a TPC command field.

In a twentieth aspect, alone or in combination with one or more of the first through nineteenth aspects, the TPC command field is indicated in at least one of a DCI format 2_2 communication or a DCI format 2_3 communication.

In a twenty-first aspect, alone or in combination with one or more of the first through twentieth aspects, the PDU set is associated with AMD, and the first transmit power and the second transmit power are indicated by the AMD.

In a twenty-second aspect, alone or in combination with one or more of the first through twenty-first aspects, process 1000 includes transmitting, via an uplink control information communication, an indication of an initial transmit power associated with transmitting or receiving the PDU set.

In a twenty-third aspect, alone or in combination with one or more of the first through twenty-second aspects, process 1000 includes receiving, via a DCI communication, an indication of the first transmit power and an indication of the second transmit power, wherein the indication of the first transmit power and the indication of the second transmit power are associated with a corresponding transmit power indication value in a TDRA table indicated by the DCI communication.

In a twenty-fourth aspect, alone or in combination with one or more of the first through twenty-third aspects, process 1000 includes increasing a transmit power from the first transmit power to the second transmit power based at least in part on receiving a reactivation downlink control information communication.

In a twenty-fifth aspect, alone or in combination with one or more of the first through twenty-fourth aspects, process 1000 includes receiving a configuration of multiple transmit power patterns.

In a twenty-sixth aspect, alone or in combination with one or more of the first through twenty-fifth aspects, process 1000 includes selecting a transmit power pattern, of the multiple transmit power patterns, based at least in part on application data unit meta data associated with the PDU set.

In a twenty-seventh aspect, alone or in combination with one or more of the first through twenty-sixth aspects, process 1000 includes adjusting a transmit power from the first transmit power to the second transmit power based at least in part on a channel state information measurement.

In a twenty-eighth aspect, alone or in combination with one or more of the first through twenty-seventh aspects, process 1000 includes adjusting a transmit power from the first transmit power to the second transmit power based at least in part on a number of received NACK communications.

In a twenty-ninth aspect, alone or in combination with one or more of the first through twenty-eighth aspects, the received NACK communications are associated with transmitting the PDU set over an unlicensed bandwidth.

In a thirtieth aspect, alone or in combination with one or more of the first through twenty-ninth aspects, the multiple transmission occasions are associated with SPS resources, the PDU set is associated with a video frame data transmission associated with a video frame periodicity, and a periodicity of the SPS resources is based at least in part on the video frame periodicity.

In a thirty-first aspect, alone or in combination with one or more of the first through thirtieth aspects, the multiple transmission occasions are associated with SPS resources, the configuration of the transmission resources include a configuration of a transmit power pattern, and the transmit power pattern is based at least in part on at least one of a periodicity associated with a number of SPS occasions, or an SPS occasion offset parameter.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with power control for multi-transmission scheduling.

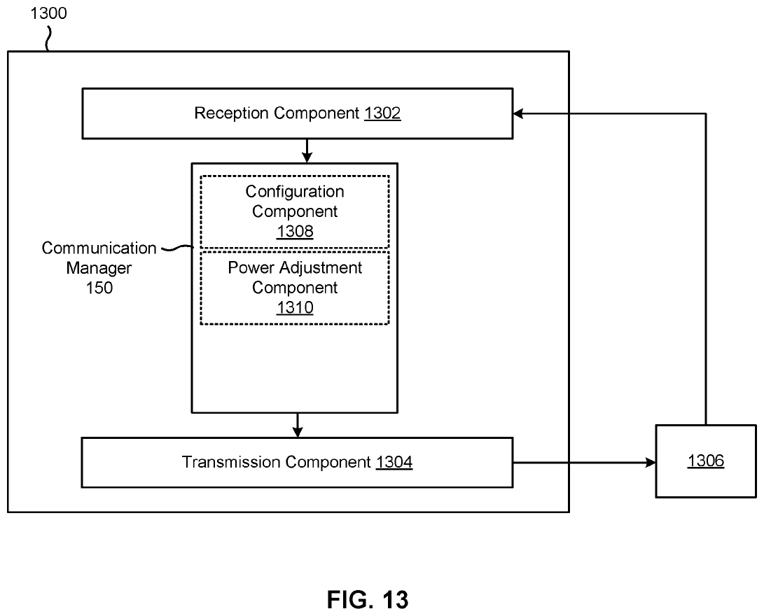

As shown in FIG. 11, in some aspects, process 1100 may include transmitting, to a UE (e.g., UE 120), a configuration of transmission resources, wherein the transmission resources are associated with multiple transmission occasions associated with a PDU set (block 1110). For example, the network node (e.g., using communication manager 150 and/or transmission component 1304, depicted in FIG. 13) may transmit, to a UE, a configuration of transmission resources, wherein the transmission resources are associated with multiple transmission occasions associated with a PDU set, as described above.

As further shown in FIG. 11, in some aspects, process 1100 may include transmitting to the UE or receiving from the UE the PDU set by: transmitting or receiving a first subset of one or more PDUs, of the PDU set, using a first subset of one or more transmission occasions, of the multiple transmission occasions, wherein the first subset of one or more PDUs is associated with a first transmit power; and transmitting or receiving a second subset of one or more PDUs, of the PDU set, using a second subset of one or more transmission occasions, of the multiple transmission occasions, wherein the second subset of one or more PDUs is associated with a second transmit power different than the first transmit power (block 1120). For example, the network node (e.g., using communication manager 150, reception component 1302, and/or transmission component 1304, depicted in FIG. 13) may transmit to the UE or receive from the UE the PDU set by: transmitting or receiving a first subset of one or more PDUs, of the PDU set, using a first subset of one or more transmission occasions, of the multiple transmission occasions, wherein the first subset of one or more PDUs is associated with a first transmit power; and transmitting or receiving a second subset of one or more PDUs, of the PDU set, using a second subset of one or more transmission occasions, of the multiple transmission occasions, wherein the second subset of one or more PDUs is associated with a second transmit power different than the first transmit power, as described above.

Process 1100 may include additional aspects, such as any single aspect or any combination of aspects described below and/or in connection with one or more other processes described elsewhere herein.

In a first aspect, the PDU set is associated with an extended reality communication.

In a second aspect, alone or in combination with the first aspect, the multiple transmission occasions are associated with one of configured grant resources, multiple physical uplink shared channel resources scheduled by one DCI communication, semi-persistent scheduled resources, or multiple physical downlink shared channel resources scheduled by one DCI communication.

In a third aspect, alone or in combination with one or more of the first and second aspects, the PDU set is associated with a PDB, the second subset of transmission occasions occurs nearer to expiration of the PDB than the first subset of transmission occasions, and the second transmit power is higher than the first transmit power.

In a fourth aspect, alone or in combination with one or more of the first through third aspects, the first subset of PDUs is associated with an I-frame associated with a compression process, and the second subset of PDUs is associated with one of a P-frame or a B-frame associated with the compression process.

In a fifth aspect, alone or in combination with one or more of the first through fourth aspects, the I-frame is associated with a higher transmit power than the one of the P-frame or the B-frame.

In a sixth aspect, alone or in combination with one or more of the first through fifth aspects, the first subset of PDUs and the second subset of PDUs are transmitted or received using a same modulation and coding scheme index.

In a seventh aspect, alone or in combination with one or more of the first through sixth aspects, the first subset of PDUs is associated with a first QoS flow, and the second subset of PDUs is associated with a second QoS flow having a higher priority than the first QoS flow.

In an eighth aspect, alone or in combination with one or more of the first through seventh aspects, process 1100 includes transmitting, to the UE, an indication of the first transmit power and the second transmit power.

In a ninth aspect, alone or in combination with one or more of the first through eighth aspects, the indication of the first transmit power and the second transmit power is transmitted in a single downlink control information communication.

In a tenth aspect, alone or in combination with one or more of the first through ninth aspects, process 1100 includes transmitting, to the UE, a configuration of a configured time threshold, wherein the first subset of PDUs is transmitted or received prior to expiration of the configured time threshold, wherein the second subset of PDUs is transmitted or received after expiration of the configured time threshold, and wherein the second transmit power is higher than the first transmit power.

In an eleventh aspect, alone or in combination with one or more of the first through tenth aspects, the configured time threshold is associated with one of a number of transmission occasions, of the multiple transmission occasions, or a number of slots after a first transmission occasion, of the multiple transmission occasions.

In a twelfth aspect, alone or in combination with one or more of the first through eleventh aspects, the configuration of the configured time threshold is transmitted via a radio resource control communication.

In a thirteenth aspect, alone or in combination with one or more of the first through twelfth aspects, a start time associated with the configured time threshold is associated with one of a slot associated with a first transmission occasion, of the multiple transmission occasions, or a start of a connected mode discontinuous reception timer.

In a fourteenth aspect, alone or in combination with one or more of the first through thirteenth aspects, process 1100 includes increasing a transmit power from the first transmit power to the second transmit power based at least in part on an expiration of the configured time threshold.

In a fifteenth aspect, alone or in combination with one or more of the first through fourteenth aspects, the multiple transmission occasions are associated with PUSCH resources associated with a same data association identifier, and the configured time threshold is associated with the PUSCH resources associated with the same data association identifier.

In a sixteenth aspect, alone or in combination with one or more of the first through fifteenth aspects, the data association identifier is indicated by one of a scheduling DCI communication associated with the multiple transmission occasions, a CG configuration included in one of a radio resource control communication or a MAC-CE communication, or an activation DCI communication activating the CG configuration.

In a seventeenth aspect, alone or in combination with one or more of the first through sixteenth aspects, process 1100 includes transmitting, to the UE, a configuration of one or more configured power transmit parameters associated with a power transmit formula.

In an eighteenth aspect, alone or in combination with one or more of the first through seventeenth aspects, the transmit power is adjusted from the first transmit power to the second transmit power based at least in part on the one or more configured power transmit parameters associated with the power transmit formula.

In a nineteenth aspect, alone or in combination with one or more of the first through eighteenth aspects, process 1100 includes transmitting, to the UE, an indication of a power adjustment parameter using a TPC command field.

In a twentieth aspect, alone or in combination with one or more of the first through nineteenth aspects, the TPC command field is indicated in at least one of a DCI format 2_2 communication or a DCI format 2_3 communication.

In a twenty-first aspect, alone or in combination with one or more of the first through twentieth aspects, the PDU set is associated with AMD, and the first transmit power and the second transmit power are indicated by the AMD.

In a twenty-second aspect, alone or in combination with one or more of the first through twenty-first aspects, process 1100 includes receiving, from the UE via an uplink control information communication, an indication of an initial transmit power associated with transmitting or receiving the PDU set.

In a twenty-third aspect, alone or in combination with one or more of the first through twenty-second aspects, process 1100 includes transmitting, to the UE via a DCI communication, an indication of the first transmit power and an indication of the second transmit power, wherein the indication of the first transmit power and the indication of the second transmit power are associated with a corresponding transmit power indication value in a TDRA table indicated by the DCI communication.

In a twenty-fourth aspect, alone or in combination with one or more of the first through twenty-third aspects, process 1100 includes transmitting, to the UE, an indication to increase a transmit power from the first transmit power to the second transmit power via a reactivation downlink control information communication.

In a twenty-fifth aspect, alone or in combination with one or more of the first through twenty-fourth aspects, process 1100 includes transmitting, to the UE, a configuration of multiple transmit power patterns.

In a twenty-sixth aspect, alone or in combination with one or more of the first through twenty-fifth aspects, a transmit power pattern, of the multiple transmit power patterns, is selected based at least in part on application data unit meta data associated with the PDU set.

In a twenty-seventh aspect, alone or in combination with one or more of the first through twenty-sixth aspects, process 1100 includes adjusting a transmit power from the first transmit power to the second transmit power based at least in part on a channel state information measurement.

In a twenty-eighth aspect, alone or in combination with one or more of the first through twenty-seventh aspects, process 1100 includes transmitting, to the UE, one or more NACK communications, wherein a transmit power is adjusted from the first transmit power to the second transmit power based at least in part on a number of the NACK communications.

In a twenty-ninth aspect, alone or in combination with one or more of the first through twenty-eighth aspects, the NACK communications are associated with transmitting the PDU set over an unlicensed bandwidth.

In a thirtieth aspect, alone or in combination with one or more of the first through twenty-ninth aspects, the multiple transmission occasions are associated with SPS resources, the PDU set is associated with a video frame data transmission associated with a video frame periodicity, and a periodicity of the SPS resources is based at least in part on the video frame periodicity.

In a thirty-first aspect, alone or in combination with one or more of the first through thirtieth aspects, the multiple transmission occasions are associated with SPS resources, the configuration of the transmission resources include a configuration of a transmit power pattern, and the transmit power pattern is based at least in part on at least one of a periodicity associated with a number of SPS occasions, or an SPS occasion offset parameter.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE (e.g., UE 120), or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE 120, a network node 110, or another wireless communication device) using the reception component 1202 and the transmission component 1204. As further shown, the apparatus 1200 may include the communication manager 140. The communication manager 140 may include one or more of a power adjustment component 1208, or a selection component 1210, among other examples.

In some aspects, the apparatus 1200 may be configured to perform one or more operations described herein in connection with FIGS. 7-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE 120 described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE 120 described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE 120 described in connection with FIG. 2. In some aspects, the transmission component 1204 may be co-located with the reception component 1202 in a transceiver.

The reception component 1202 may receive a configuration of transmission resources, wherein the transmission resources are associated with multiple transmission occasions associated with a PDU set. The transmission component 1204 and/or the reception component 1202 may transmit or receive the PDU set by transmitting or receiving a first subset of one or more PDUs, of the PDU set, using a first subset of one or more transmission occasions, of the multiple transmission occasions, wherein the first subset of one or more PDUs is associated with a first transmit power; and transmitting or receiving a second subset of one or more PDUs, of the PDU set, using a second subset of one or more transmission occasions, of the multiple transmission occasions, wherein the second subset of one or more PDUs is associated with a second transmit power different than the first transmit power.

The reception component 1202 may receive an indication of the first transmit power and the second transmit power. Additionally, or alternatively, the reception component 1202 may receive a configuration of a configured time threshold, wherein the first subset of PDUs is transmitted or received prior to expiration of the configured time threshold, wherein the second subset of PDUs is transmitted or received after expiration of the configured time threshold, and wherein the second transmit power is higher than the first transmit power.

The power adjustment component 1208 may increase a transmit power from the first transmit power to the second transmit power based at least in part on an expiration of the configured time threshold. Additionally, or alternatively, the power adjustment component 1208 may adjust a transmit power from the first transmit power to the second transmit power based at least in part on one or more configured power transmit parameters associated with a power transmit formula. Additionally, or alternatively, the power adjustment component 1208 may adjust the transmit power from the second transmit power to a maximum permitted transmit power based at least in part on the one or more configured power transmit parameters associated with the power transmit formula. Additionally, or alternatively, the power adjustment component 1208 may adjust a transmit power from the first transmit power to the second transmit power based at least in part on a power adjustment parameter indicated by a TPC command field.

The transmission component 1204 may transmit, via an uplink control information communication, an indication of an initial transmit power associated with transmitting or receiving the PDU set. The reception component 1202 may receive, via a DCI communication, an indication of the first transmit power and an indication of the second transmit power, wherein the indication of the first transmit power and the indication of the second transmit power are associated with a corresponding transmit power indication value in a TDRA table indicated by the DCI communication.

The power adjustment component 1208 may increase a transmit power from the first transmit power to the second transmit power based at least in part on receiving a reactivation downlink control information communication.

The reception component 1202 may receive a configuration of multiple transmit power patterns. The selection component 1210 may select a transmit power pattern, of the multiple transmit power patterns, based at least in part on application data unit meta data associated with the PDU set.

The power adjustment component 1208 may adjust a transmit power from the first transmit power to the second transmit power based at least in part on a channel state information measurement. Additionally, or alternatively, the power adjustment component 1208 may adjust a transmit power from the first transmit power to the second transmit power based at least in part on a number of received NACK communications.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node (e.g., network node 110), or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE 120, a network node 110, or another wireless communication device) using the reception component 1302 and the transmission component 1304. As further shown, the apparatus 1300 may include the communication manager 150. The communication manager 150 may include a configuration component 1308 or a power adjustment component 1310, among other examples.

In some aspects, the apparatus 1300 may be configured to perform one or more operations described herein in connection with FIGS. 7-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node 110 described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node 110 described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node 110 described in connection with FIG. 2. In some aspects, the transmission component 1304 may be co-located with the reception component 1302 in a transceiver.

The transmission component 1304 and/or the configuration component 1308 may transmit, to a UE (e.g., UE 120), a configuration of transmission resources, wherein the transmission resources are associated with multiple transmission occasions associated with a PDU set. The transmission component 1304 and/or the reception component 1302 may transmit to the UE or receive from the UE the PDU set by transmitting or receiving a first subset of one or more PDUs, of the PDU set, using a first subset of one or more transmission occasions, of the multiple transmission occasions, wherein the first subset of one or more PDUs is associated with a first transmit power; and transmitting or receiving a second subset of one or more PDUs, of the PDU set, using a second subset of one or more transmission occasions, of the multiple transmission occasions, wherein the second subset of one or more PDUs is associated with a second transmit power different than the first transmit power.

The transmission component 1304 may transmit, to the UE, an indication of the first transmit power and the second transmit power. Additionally, or alternatively, the transmission component 1304 and/or the configuration component 1308 may transmit, to the UE, a configuration of a configured time threshold, wherein the first subset of PDUs is transmitted or received prior to expiration of the configured time threshold, wherein the second subset of PDUs is transmitted or received after expiration of the configured time threshold, and wherein the second transmit power is higher than the first transmit power.

The power adjustment component 1310 may increase a transmit power from the first transmit power to the second transmit power based at least in part on an expiration of the configured time threshold.

The transmission component 1304 and/or the configuration component 1308 may transmit, to the UE, a configuration of one or more configured power transmit parameters associated with a power transmit formula.

The transmission component 1304 may transmit, to the UE, an indication of a power adjustment parameter using a TPC command field.

The reception component 1302 may receive, from the UE via an uplink control information communication, an indication of an initial transmit power associated with transmitting or receiving the PDU set.

The transmission component 1304 may transmit, to the UE via a DCI communication, an indication of the first transmit power and an indication of the second transmit power, wherein the indication of the first transmit power and the indication of the second transmit power are associated with a corresponding transmit power indication value in a TDRA table indicated by the DCI communication. Additionally, or alternatively, the transmission component 1304 may transmit, to the UE, an indication to increase a transmit power from the first transmit power to the second Additionally, or alternatively, the transmission component 1304 and/or the configuration component 1308 may transmit, to the UE, a configuration of multiple transmit power patterns.

The power adjustment component 1310 may adjust a transmit power from the first transmit power to the second transmit power based at least in part on a channel state information measurement.

The transmission component 1304 may transmit, to the UE, one or more NACK communications, wherein a transmit power is adjusted from the first transmit power to the second transmit power based at least in part on a number of the NACK communications.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:
Aspect 1: A method of wireless communication performed by a UE, comprising: receiving a configuration of transmission resources, wherein the transmission resources are associated with multiple transmission occasions associated with a PDU set; and transmitting or receiving the PDU set by: transmitting or receiving a first subset of one or more PDUs, of the PDU set, using a first subset of one or more transmission occasions, of the multiple transmission occasions, wherein the first subset of one or more PDUs is associated with a first transmit power; and transmitting or receiving a second subset of one or more PDUs, of the PDU set, using a second subset of one or more transmission occasions, of the multiple transmission occasions, wherein the second subset of one or more PDUs is associated with a second transmit power different than the first transmit power.
Aspect 2: The method of Aspect 1, wherein the PDU set is associated with an extended reality communication.
Aspect 3: The method of any of Aspects 1-2, wherein the multiple transmission occasions are associated with one of: configured grant resources, multiple physical uplink shared channel resources scheduled by DCI communication, semi-persistent scheduled resources, or multiple physical downlink shared channel resources scheduled by one DCI communication.
Aspect 4: The method of any of Aspects 1-3, wherein the PDU set is associated with a PDB, wherein the second subset of transmission occasions occurs nearer to expiration of the PDB than the first subset of transmission occasions, and wherein the second transmit power is higher than the first transmit power.
Aspect 5: The method of any of Aspects 1-4, wherein the first subset of PDUs is associated with an I-frame associated with a compression process, and wherein the second subset of PDUs is associated with one of a P-frame or a B-frame associated with the compression process.
Aspect 6: The method of Aspect 5, wherein the I-frame is associated with a higher transmit power than the one of the P-frame or the B-frame.
Aspect 7: The method of any of Aspects 1-6, wherein the first subset of PDUs and the second subset of PDUs are transmitted or received using a same modulation and coding scheme index.
Aspect 8: The method of any of Aspects 1-7, wherein the first subset of PDUs is associated with a first QoS flow, and wherein the second subset of PDUs is associated with a second QoS flow having a higher priority than the first QoS flow.
Aspect 9: The method of any of Aspects 1-8, further comprising receiving an indication of the first transmit power and the second transmit power.
Aspect 10: The method of Aspect 9, wherein the indication of the first transmit power and the second transmit power is received in a single downlink control information communication.
Aspect 11: The method of any of Aspects 1-10, further comprising receiving a configuration of a configured time threshold, wherein the first subset of PDUs is transmitted or received prior to expiration of the configured time threshold, wherein the second subset of PDUs is transmitted or received after expiration of the configured time threshold, and wherein the second transmit power is higher than the first transmit power.
Aspect 12: The method of Aspect 11, wherein the configured time threshold is associated with one of a number of transmission occasions, of the multiple transmission occasions, or a number of slots after a first transmission occasion, of the multiple transmission occasions.
Aspect 13: The method of any of Aspects 11-12, wherein the configuration of the configured time threshold is received via a radio resource control communication.
Aspect 14: The method of any of Aspects 11-13, wherein a start time associated with the configured time threshold is associated with one of a slot associated with a first transmission occasion, of the multiple transmission occasions, or a start of a connected mode discontinuous reception timer.
Aspect 15: The method of any of Aspects 11-14, further comprising increasing a transmit power from the first transmit power to the second transmit power based at least in part on an expiration of the configured time threshold.
Aspect 16: The method of any of Aspects 11-15, wherein the multiple transmission occasions are associated with PUSCH resources associated with a same data association identifier, and wherein the configured time threshold is associated with the PUSCH resources associated with the same data association identifier.
Aspect 17: The method of Aspect 16, wherein the data association identifier is indicated by one of: a scheduling DCI communication associated with the multiple transmission occasions, a CG configuration included in one of a radio resource control communication or a MAC-CE communication, or an activation DCI communication activating the CG configuration.
Aspect 18: The method of any of Aspects 1-17, further comprising adjusting a transmit power from the first transmit power to the second transmit power based at least in part on one or more configured power transmit parameters associated with a power transmit formula.
Aspect 19: The method of Aspect 18, further comprising adjusting the transmit power from the second transmit power to a maximum permitted transmit power based at least in part on the one or more configured power transmit parameters associated with the power transmit formula.
Aspect 20: The method of any of Aspects 1-19, further comprising adjusting a transmit power from the first transmit power to the second transmit power based at least in part on a power adjustment parameter indicated by a TPC command field.
Aspect 21: The method of Aspect 20, wherein the TPC command field is indicated in at least one of a DCI format 2_2 communication or a DCI format 2_3 communication.
Aspect 22: The method of any of Aspects 1-21, wherein the PDU set is associated with AMD, and wherein the first transmit power and the second transmit power are indicated by the AMD
Aspect 23: The method of any of Aspects 1-22, further comprising transmitting, via an uplink control information communication, an indication of an initial transmit power associated with transmitting or receiving the PDU set.
Aspect 24: The method of any of Aspects 1-23, further comprising receiving, via a DCI communication, an indication of the first transmit power and an indication of the second transmit power, wherein the indication of the first transmit power and the indication of the second transmit power are associated with a corresponding transmit power indication value in a TDRA table indicated by the DCI communication.
Aspect 25: The method of any of Aspects 1-24, further comprising increasing a transmit power from the first transmit power to the second transmit power based at least in part on receiving a reactivation downlink control information communication.
Aspect 26: The method of any of Aspects 1-25, further comprising receiving a configuration of multiple transmit power patterns.
Aspect 27: The method of Aspect 26, further comprising selecting a transmit power pattern, of the multiple transmit power patterns, based at least in part on application data unit meta data associated with the PDU set.
Aspect 28: The method of any of Aspects 1-27, further comprising adjusting a transmit power from the first transmit power to the second transmit power based at least in part on a channel state information measurement.
Aspect 29: The method of any of Aspects 1-28, further comprising adjusting a transmit power from the first transmit power to the second transmit power based at least in part on a number of received NACK communications.
Aspect 30: The method of Aspect 29, wherein the received NACK communications are associated with transmitting the PDU set over an unlicensed bandwidth.
Aspect 31: The method of any of Aspects 1-30, wherein the multiple transmission occasions are associated with SPS resources, wherein the PDU set is associated with a video frame data transmission associated with a video frame periodicity, and wherein a periodicity of the SPS resources is based at least in part on the video frame periodicity.
Aspect 32: The method of any of Aspects 1-31, wherein the multiple transmission occasions are associated with SPS resources, wherein the configuration of the transmission resources include a configuration of a transmit power pattern, and wherein the transmit power pattern is based at least in part on at least one of a periodicity associated with a number of SPS occasions, or an SPS occasion offset parameter.
Aspect 33: A method of wireless communication performed by a network node, comprising: transmitting, to a UE, a configuration of transmission resources, wherein the transmission resources are associated with multiple transmission occasions associated with a PDU set; and transmitting to the UE or receiving from the UE the PDU set by: transmitting or receiving a first subset of one or more PDUs, of the PDU set, using a first subset of one or more transmission occasions, of the multiple transmission occasions, wherein the first subset of one or more PDUs is associated with a first transmit power; and transmitting or receiving a second subset of one or more PDUs, of the PDU set, using a second subset of one or more transmission occasions, of the multiple transmission occasions, wherein the second subset of one or more PDUs is associated with a second transmit power different than the first transmit power.
Aspect 34: The method of Aspect 33, wherein the PDU set is associated with an extended reality communication.
Aspect 35: The method of any of Aspects 33-34, wherein the multiple transmission occasions are associated with one of: configured grant resources, multiple physical uplink shared channel resources scheduled by one DCI communication, semi-persistent scheduled resources, or multiple physical downlink shared channel resources scheduled by one DCI communication.
Aspect 36: The method of any of Aspects 33-35, wherein the PDU set is associated with a PDB, wherein the second subset of transmission occasions occurs nearer to expiration of the PDB than the first subset of transmission occasions, and wherein the second transmit power is higher than the first transmit power.
Aspect 37: The method of any of Aspects 33-36, wherein the first subset of PDUs is associated with an I-frame associated with a compression process, and wherein the second subset of PDUs is associated with one of a P-frame or a B-frame associated with the compression process.
Aspect 38: The method of Aspect 37, wherein the I-frame is associated with a higher transmit power than the one of the P-frame or the B-frame.
Aspect 39: The method of any of Aspects 33-38, wherein the first subset of PDUs and the second subset of PDUs are transmitted or received using a same modulation and coding scheme index.
Aspect 40: The method of any of Aspects 33-39, wherein the first subset of PDUs is associated with a first QoS flow, and wherein the second subset of PDUs is associated with a second QoS flow having a higher priority than the first QoS flow.
Aspect 41: The method of any of Aspects 33-40, further comprising transmitting, to the UE, an indication of the first transmit power and the second transmit power.
Aspect 42: The method of Aspect 41, wherein the indication of the first transmit power and the second transmit power is transmitted in a single downlink control information communication.
Aspect 43: The method of any of Aspects 33-42, further comprising transmitting, to the UE, a configuration of a configured time threshold, wherein the first subset of PDUs is transmitted or received prior to expiration of the configured time threshold, wherein the second subset of PDUs is transmitted or received after expiration of the configured time threshold, and wherein the second transmit power is higher than the first transmit power.
Aspect 44: The method of Aspect 43, wherein the configured time threshold is associated with one of a number of transmission occasions, of the multiple transmission occasions, or a number of slots after a first transmission occasion, of the multiple transmission occasions.
Aspect 45: The method of any of Aspects 43-44, wherein the configuration of the configured time threshold is transmitted via a radio resource control communication.
Aspect 46: The method of any of Aspects 43-45, wherein a start time associated with the configured time threshold is associated with one of a slot associated with a first transmission occasion, of the multiple transmission occasions, or a start of a connected mode discontinuous reception timer.
Aspect 47: The method of any of Aspects 43-46, further comprising increasing a transmit power from the first transmit power to the second transmit power based at least in part on an expiration of the configured time threshold.
Aspect 48: The method of any of Aspects 43-47, wherein the multiple transmission occasions are associated with PUSCH resources associated with a same data association identifier, and wherein the configured time threshold is associated with the PUSCH resources associated with the same data association identifier.
Aspect 49: The method of Aspect 48, wherein the data association identifier is indicated by one of: a scheduling DCI communication associated with the multiple transmission occasions, a CG configuration included in one of a radio resource control communication or a MAC-CE communication, or an activation DCI communication activating the CG configuration.
Aspect 50: The method of any of Aspects 33-49, further comprising transmitting, to the UE, a configuration of one or more configured power transmit parameters associated with a power transmit formula.
Aspect 51: The method of Aspect 50, wherein the transmit power is adjusted from the first transmit power to the second transmit power based at least in part on the one or more configured power transmit parameters associated with the power transmit formula.
Aspect 52: The method of any of Aspects 33-51, further comprising transmitting, to the UE, an indication of a power adjustment parameter using a TPC command field.
Aspect 53: The method of Aspect 52, wherein the TPC command field is indicated in at least one of a DCI format 2_2 communication or a DCI format 2_3 communication.
Aspect 54: The method of any of Aspects 33-53, wherein the PDU set is associated with AMD, and wherein the first transmit power and the second transmit power are indicated by the AMD.
Aspect 55: The method of any of Aspects 33-54, further comprising receiving, from the UE via an uplink control information communication, an indication of an initial transmit power associated with transmitting or receiving the PDU set.
Aspect 56: The method of any of Aspects 33-55, further comprising transmitting, to the UE via a DCI communication, an indication of the first transmit power and an indication of the second transmit power, wherein the indication of the first transmit power and the indication of the second transmit power are associated with a corresponding transmit power indication value in a TDRA table indicated by the DCI communication.
Aspect 57: The method of any of Aspects 33-56, further comprising transmitting, to the UE, an indication to increase a transmit power from the first transmit power to the second transmit power via a reactivation downlink control information communication.
Aspect 58: The method of any of Aspects 33-57, further comprising transmitting, to the UE, a configuration of multiple transmit power patterns.
Aspect 59: The method of Aspect 58, wherein a transmit power pattern, of the multiple transmit power patterns, is selected based at least in part on application data unit meta data associated with the PDU set.
Aspect 60: The method of any of Aspects 33-59, further comprising adjusting a transmit power from the first transmit power to the second transmit power based at least in part on a channel state information measurement.
Aspect 61: The method of any of Aspects 33-60, further comprising transmitting, to the UE, one or more NACK communications, wherein a transmit power is adjusted from the first transmit power to the second transmit power based at least in part on a number of the NACK communications.
Aspect 62: The method of Aspect 61, wherein the NACK communications are associated with transmitting the PDU set over an unlicensed bandwidth.
Aspect 63: The method of any of Aspects 33-63, wherein the multiple transmission occasions are associated with SPS resources, wherein the PDU set is associated with a video frame data transmission associated with a video frame periodicity, and wherein a periodicity of the SPS resources is based at least in part on the video frame periodicity.
Aspect 64: The method of any of Aspects 33-63, wherein the multiple transmission occasions are associated with SPS resources, wherein the configuration of the transmission resources include a configuration of a transmit power pattern, and wherein the transmit power pattern is based at least in part on at least one of a periodicity associated with a number of SPS occasions, or an SPS occasion offset parameter.
Aspect 65: An apparatus for wireless communication at a device, comprising a processor; memory coupled with the processor; and instructions stored in the memory and executable by the processor to cause the apparatus to perform the method of one or more of Aspects 1-32.
Aspect 66: A device for wireless communication, comprising a memory and one or more processors coupled to the memory, the one or more processors configured to perform the method of one or more of Aspects 1-32.
Aspect 67: An apparatus for wireless communication, comprising at least one means for performing the method of one or more of Aspects 1-32.
Aspect 68: A non-transitory computer-readable medium storing code for wireless communication, the code comprising instructions executable by a processor to perform the method of one or more of Aspects 1-32.
Aspect 69: A non-transitory computer-readable medium storing a set of instructions for wireless communication, the set of instructions comprising one or more instructions that, when executed by one or more processors of a device, cause the device to perform the method of one or more of Aspects 1-32.
Aspect 70: An apparatus for wireless communication at a device, comprising a processor; memory coupled with the processor; and instructions stored in the memory and executable by the processor to cause the apparatus to perform the method of one or more of Aspects 33-64.
Aspect 71: A device for wireless communication, comprising a memory and one or more processors coupled to the memory, the one or more processors configured to perform the method of one or more of Aspects 33-64.
Aspect 72: An apparatus for wireless communication, comprising at least one means for performing the method of one or more of Aspects 33-64.
Aspect 73: A non-transitory computer-readable medium storing code for wireless communication, the code comprising instructions executable by a processor to perform the method of one or more of Aspects 33-64.
Aspect 74: A non-transitory computer-readable medium storing a set of instructions for wireless communication, the set of instructions comprising one or more instructions that, when executed by one or more processors of a device, cause the device to perform the method of one or more of Aspects 33-64.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
receiving a configuration of transmission resources, wherein the transmission resources are associated with multiple transmission occasions associated with a packet data unit (PDU) set; and
transmitting or receiving the PDU set by:
transmitting or receiving a first subset of one or more PDUs, of the PDU set, using a first subset of one or more transmission occasions, of the multiple transmission occasions, wherein the first subset of one or more PDUs is associated with a first transmit power; and
transmitting or receiving a second subset of one or more PDUs, of the PDU set, using a second subset of one or more transmission occasions, of the multiple transmission occasions, wherein the second subset of one or more PDUs is associated with a second transmit power different than the first transmit power.

2-4. (canceled)

5. The method of claim 1, wherein the first subset of PDUs is associated with an intra-coded frame (I-frame) associated with a compression process, and wherein the second subset of PDUs is associated with one of a predicted frame (P-frame) or a bidirectional predicted frame (B-frame) associated with the compression process.

6-32. (canceled)

33. A method of wireless communication performed by a network node, comprising:
transmitting, to a user equipment (UE), a configuration of transmission resources, wherein the transmission resources are associated with multiple transmission occasions associated with a packet data unit (PDU) set; and
transmitting to the UE or receiving from the UE the PDU set by:
transmitting or receiving a first subset of one or more PDUs, of the PDU set, using a first subset of one or more transmission occasions, of the multiple transmission occasions, wherein the first subset of one or more PDUs is associated with a first transmit power; and
transmitting or receiving a second subset of one or more PDUs, of the PDU set, using a second subset of one or more transmission occasions, of the multiple transmission occasions, wherein the second subset of one or more PDUs is associated with a second transmit power different than the first transmit power.

34-39. (canceled)

40. The method of claim 33, wherein the first subset of PDUs is associated with a first quality of service (QOS) flow, and wherein the second subset of PDUs is associated with a second QOS flow having a higher priority than the first QoS flow.

41-64. (canceled)

65. An apparatus for wireless communication at a user equipment (UE), comprising:
a memory; and
one or more processors, coupled to the memory, configured to:
receive a configuration of transmission resources, wherein the transmission resources are associated with multiple transmission occasions associated with a packet data unit (PDU) set; and
transmit or receive the PDU set by:
transmitting or receiving a first subset of one or more PDUs, of the PDU set, using a first subset of one or more transmission occasions, of the multiple transmission occasions, wherein the first subset of one or more PDUs is associated with a first transmit power; and
transmitting or receiving a second subset of one or more PDUs, of the PDU set, using a second subset of one or more transmission occasions, of the multiple transmission occasions, wherein the second subset of one or more PDUs is associated with a second transmit power different than the first transmit power.

66-67. (canceled)

68. The apparatus of claim 65, wherein the PDU set is associated with a packet delay budget (PDB), wherein the second subset of transmission occasions occurs nearer to expiration of the PDB than the first subset of transmission occasions, and wherein the second transmit power is higher than the first transmit power.

69. The apparatus of claim 65, wherein the first subset of PDUs is associated with an intra-coded frame (I-frame) associated with a compression process, and wherein the second subset of PDUs is associated with one of a predicted frame (P-frame) or a bidirectional predicted frame (B-frame) associated with the compression process.

70-71. (canceled)

72. The apparatus of claim 65, wherein the first subset of PDUs is associated with a first quality of service (QOS) flow, and wherein the second subset of PDUs is associated with a second QoS flow having a higher priority than the first QoS flow.

73. The apparatus of claim 65, wherein the one or more processors are further configured to receive an indication of the first transmit power and the second transmit power.

74. The apparatus of claim 73, wherein the indication of the first transmit power and the second transmit power is received in a single downlink control information communication.

75. The apparatus of claim 65, wherein the one or more processors are further configured to receive a configuration of a configured time threshold, wherein the first subset of PDUs is transmitted or received prior to expiration of the configured time threshold, wherein the second subset of PDUs is transmitted or received after expiration of the configured time threshold, and wherein the second transmit power is higher than the first transmit power.

76. The apparatus of claim 75, wherein the configured time threshold is associated with one of a number of transmission occasions, of the multiple transmission occasions, or a number of slots after a first transmission occasion, of the multiple transmission occasions.

77. (canceled)

78. The apparatus of claim 75, wherein a start time associated with the configured time threshold is associated with one of a slot associated with a first transmission occasion, of the multiple transmission occasions, or a start of a connected mode discontinuous reception timer.

79. The apparatus of claim 75, wherein the one or more processors are further configured to increase a transmit power from the first transmit power to the second transmit power based at least in part on an expiration of the configured time threshold.

80. The apparatus of claim 75, wherein the multiple transmission occasions are associated with physical uplink shared channel (PUSCH) resources associated with a same data association identifier, and wherein the configured time threshold is associated with the PUSCH resources associated with the same data association identifier.

81. (canceled)

82. The apparatus of claim 65, wherein the one or more processors are further configured to adjust a transmit power from the first transmit power to the second transmit power based at least in part on one or more configured power transmit parameters associated with a power transmit formula.

83. The apparatus of claim 82, wherein the one or more processors are further configured to adjust the transmit power from the second transmit power to a maximum permitted transmit power based at least in part on the one or more configured power transmit parameters associated with the power transmit formula.

84. The apparatus of claim 65, wherein the one or more processors are further configured to adjust a transmit power from the first transmit power to the second transmit power based at least in part on a power adjustment parameter indicated by a transmit power control (TPC) command field.

85. (canceled)

86. The apparatus of claim 65, wherein the PDU set is associated with application data unit (ADU) meta data (AMD), and wherein the first transmit power and the second transmit power are indicated by the AMD.

87. (canceled)

88. The apparatus of claim 65, wherein the one or more processors are further configured to receive, via a downlink control information (DCI) communication, an indication of the first transmit power and an indication of the second transmit power, wherein the indication of the first transmit power and the indication of the second transmit power are associated with a corresponding transmit power indication value in a time domain resource allocation (TDRA) table indicated by the DCI communication.

89. The apparatus of claim 65, wherein the one or more processors are further configured to increase a transmit power from the first transmit power to the second transmit power based at least in part on receiving a reactivation downlink control information communication.

90. The apparatus of claim 65, wherein the one or more processors are further configured to receive a configuration of multiple transmit power patterns.

91. The apparatus of claim 90, wherein the one or more processors are further configured to select a transmit power pattern, of the multiple transmit power patterns, based at least in part on application data unit meta data associated with the PDU set.

92. The apparatus of claim 65, wherein the one or more processors are further configured to adjust a transmit power from the first transmit power to the second transmit power based at least in part on a channel state information measurement.

93. The apparatus of claim 65, wherein the one or more processors are further configured to adjust a transmit power from the first transmit power to the second transmit power based at least in part on a number of received negative acknowledgement (NACK) communications.

94. The apparatus of claim 93, wherein the received NACK communications are associated with transmitting the PDU set over an unlicensed bandwidth.

95. The apparatus of claim 65, wherein the multiple transmission occasions are associated with semi-persistent scheduled (SPS) resources, wherein the PDU set is associated with a video frame data transmission associated with a video frame periodicity, and wherein a periodicity of the SPS resources is based at least in part on the video frame periodicity.

96. The apparatus of claim 65, wherein the multiple transmission occasions are associated with semi-persistent scheduled (SPS) resources, wherein the configuration of the transmission resources includes a configuration of a transmit power pattern, and wherein the transmit power pattern is based at least in part on at least one of a periodicity associated with a number of SPS occasions, or an SPS occasion offset parameter.

97. An apparatus for wireless communication at a network node, comprising:
a memory; and
one or more processors, coupled to the memory, configured to:
transmit, to a user equipment (UE), a configuration of transmission resources, wherein the transmission resources are associated with multiple transmission occasions associated with a packet data unit (PDU) set; and
transmit to the UE or receive from the UE the PDU set by:
transmitting or receiving a first subset of one or more PDUs, of the PDU set, using a first subset of one or more transmission occasions, of the multiple transmission occasions, wherein the first subset of one or more PDUs is associated with a first transmit power; and
transmitting or receiving a second subset of one or more PDUs, of the PDU set, using a second subset of one or more transmission occasions, of the multiple transmission occasions, wherein the second subset of one or more PDUs is associated with a second transmit power different than the first transmit power.

98-99. (canceled)

100. The apparatus of claim 97, wherein the PDU set is associated with a packet delay budget (PDB), wherein the second subset of transmission occasions occurs nearer to expiration of the PDB than the first subset of transmission occasions, and wherein the second transmit power is higher than the first transmit power.

101-256. (canceled)
